(19) United States
(12) Patent Application Publication
(10) Pub. No.: US 2006/0140404 A1
(43) Pub. Date: Jun. 29, 2006

(54) System for managing encrypted code, data processor and electronic apparatus

(76) Inventor: Kazuya Oyama, (US)

Correspondence Address: BIRCH STEWART KOLASCH & BIRCH, PO BOX 747, FALLS CHURCH, VA, 22040-0747, US

(21) Appl. No.: 10/543,009

(22) PCT Filed: Mar. 3, 2004
(86) PCT No.: PCT/JP04/02672

§ 371 Date: Jul. 22, 2005

(30) Foreign Application Priority Data
Mar. 7, 2003 (JP) 2003-62089

(51) Int. Cl. H04N 7/167

(52) U.S. Cl. 380/201

(57) ABSTRACT

After receiving and storing the ID code A of an AV data transmitter (3), a remote controller (5) for managing ID receives the ID code A or B of any one of AV data receiver 4a or 4b. When the ID code A of the AV data receiver 4a is received, connectibility of communication is confirmed because the ID codes coincide with each other. When the ID code B of the AV data receiver 4b is received, nonconnectibility of communication is confirmed because the ID codes do not coincide with each other.

### TECHNICAL FIELD

The present invention relates to an encryption code management system for use with a data transmitter that transmits data after encrypting it with an encryption code and a data receiver that receives encrypted data and decodes it. The present invention also relates to a data processor, such as a data transmitter or data receiver, for use in such an encryption code management system, and to an electronic apparatus for use in such an encryption code management system.

### BACKGROUND ART

In recent years, inconveniences associated with wired connection and advancements in wireless technologies have led to the commercial availability of AV data wireless communication systems that permit transmission of AV data from an AV source appliance, such as a tuner, videocassette player, or DVD player, to an AV reproduction appliance, such as a display or projector, so that video and audio are displayed or otherwise outputted on the AV reproduction appliance. To realize such an AV data wireless communication system, an AV data transmitter for transmitting AV data is connected to an AV source appliance, and an AV data receiver is connected to an AV reproduction appliance. Alternatively, an AV data transmitter is incorporated in an AV reproduction appliance and an AV data receiver is incorporated in an AV reproduction appliance so that an AV data wireless communication system is built with the AV source appliance and AV reproduction appliance alone.

Since AV data is copy-righted, this type of AV data wireless communication system is built with an AV data transmitter and an AV data receiver that are designed to operate in one-to-one correspondence so that the same AV data cannot be transmitted between an AV data transmitter and an AV data receiver that belong to another system. FIG. 37 shows the configuration of a conventional AV data wireless communication systems.

In FIG. 37, one AV data wireless communication system is built. In this AV data wireless communication system, AV data outputted from an AV source appliance 1 is transmitted from an antenna 511 of an AV data transmitter 101 that is cable-connected to the AV source appliance 1. This AV data from the AV source appliance 1 is received by an AV data receiver 102 via an antenna 541, thereof, and is then fed to an AV reproduction appliance 2 that is cable-connected to the AV data receiver 102, so that the AV data is reproduced for display.

When a remote control unit (remote commander) 11 for operating the AV source appliance 1 is operated and an infrared signal is transmitted, this infrared signal is received by a remote control data reception portion 553 of the AV data receiver 102, is then converted into a signal for wireless communication, and is then transmitted from the antenna 541. When this signal is received by the AV data transmitter 101 via the antenna 511 thereof, it is then converted into an infrared signal, is then transmitted from a remote control output portion 517, and is then received by an infrared signal reception portion 12 of the AV source appliance 1, which thus performs the operation specified on the remote control unit 11.

As shown in FIG. 38, the AV data transmitter 101 mentioned above includes an analog input portion 502 to which analog AV data, such as NTSC-compatible data, is fed and a digital input portion 501 to which a digital signal is fed. Analog data is converted into digital data by an A/D conversion portion (hereinafter simply “A/D”) 503, and is then encoded by an MPEG portion 504. The data, containing various kinds of data, is then arranged by a data generation portion 505, then has error correction codes added thereto by an error correction code addition portion 506, is then encrypted (scrambled) by a data scrambling portion 507, and is then transmitted, via a baseband (hereinafter simply “BB”) 509, a radio-frequency amplifier circuit (hereinafter simply “RF”) 510, and the antenna 511, to the AV data receiving side. Here, the ID used for scrambling by the data scrambling portion 507 is stored in an ID storage portion 520. When the inputted data is digital data, it is fed from the digital input portion 501 directly to the data generation portion 505.

In the AV data receiver 102, which is configured as shown in FIG. 39, AV data is received via the antenna 541, an RF 542, and a BB 543, is then descrambled by a descrambling portion 544, is then analyzed by a data analysis portion 545 for data sorting and integrity checking, is then decoded by an MPEG portion 546, is then converted into an analog signal by a D/A conversion portion (hereinafter simply “D/A”) 547, and is then outputted as data, such as NTSC-compatible data, from an analog output portion 548. Here, the ID used for descrambling by the descrambling portion 544 is stored in an ID storage portion 560. When digital data is outputted, the data from the data analysis portion 545 is outputted via a digital output analysis portion 549 and a digital output portion 550.

The AV data receiver 102 also checks for packets that have failed to be correctly received by the data analysis portion 545. Based on the results of this checking, a re-send request packet generation portion 558 generates packets for requesting the re-sending of the unreceived packets. The AV data receiver 102 further includes an operation portion 551 via which signals for controlling the AV source appliance 1 are fed in and a remote control data reception portion 553 that receives infrared signals from the remote control unit 11. Data from the operation portion 551 is converted by an input data conversion portion 552, and signals received by the remote control data reception portion 553 are converted by a remote control data conversion portion 554. From packets based on the thus converted data and the re-send request packets from the re-send request packet generation portion 558, transmission data is generated by a data generation portion 555, and has then error correction codes added thereto by an error correction code addition portion 556. This transmission data is then scrambled by a data scrambling portion 557, and is the transmitted via the BB 543, the RF 542, and the antenna 541.

When this data is received by the AV data transmitter 101 via the antenna 511, the RF 510, and the BB 509, it is descrambled by a descrambling portion 512, and is then fed to a data analysis portion 513, which checks for packets that have failed to be correctly received by the AV data receiver 102 and arranges the data. If re-sending is necessary, data packets of the AV data of which the re-sending is requested is generated by a re-send request packet generation portion 514. The data recognized by the data analysis portion 513 as data for operating the AV source appliance 1 is converted into remote control signals by a remote control data analysis portion 516, and is then outputted as infrared signals from the remote control output portion 517. Digital data other than the remote control signals is outputted via the digital data analysis portion 518 from the digital data output portion 519.

In FIG. 37, the ID code recorded in the AV data transmitter 101 and the AV data receiver 102 that build the wireless communication system is fixed to “A”. Here, if an AV data receiver 103 belonging to another wireless communication system is present, the ID code of this AV data receiver 103 is fixed to “B”. This AV data receiver 103 lacks the analog output portion 548 and the digital output portion 550, and instead incorporates the function of the AV reproduction appliance 2. However, since the ID code “A” of the AV data transmitter 101 is different from the ID code “B” of the AV data receiver 103, wireless transmission is impossible between the AV data transmitter 101 and the AV data receiver 103.

As described above, in the AV data wireless communication system shown in FIG. 37, wireless transmission of AV data is possible only between a predetermined combination of AV appliances, and thus the user cannot freely enjoy an arbitrary AV data source at an arbitrary place wirelessly. However, if a number of AV data receivers are simultaneously present that can receive, descramble, and decode AV data that is transmitted wirelessly in a form encrypted as by scrambling, those AV data receivers permit a number of persons to enjoy the same AV data. This may violate the copyright of AV source authors.

On the other hand, a system that permits free setting of codes associated with scrambling, descrambling, encryption, and decoding is vulnerable to eavesdropping or the like. Moreover, in a system that involves re-sending or the like, if a plurality of AV data receivers are present in the system and they randomly request re-sending, re-send requests may concentrate to cause bandwidth shortage, or the AV data receivers may be hindered from stable reception.

To overcome these inconveniences, according to one conventional technique, a hot-water-supply system is proposed wherein an ID is exchanged between the main unit thereof and a remote control unit for controlling it so that only the most recent remote control unit is made usable (see Japanese Patent Application Laid-Open No. H7-255089). This system makes only the most recent ID code valid, and thus does not permit the same ID code to be set for a plurality of appliances. According to another conventional technique, an intercom system is proposed wherein an additionally installed master unit transmits its own ID so that another additionally installed master unit that has received it uses an ID different therefrom (see Japanese Patent Application Laid-Open No. H11-284754).

In the AV data wireless communication system shown in FIG. 37, communication may fail to be established between the AV data transmitter 101 and the AV data receiver 102 or between the AV data transmitter 101 and the AV data receiver 103. In such cases, there is no way of easily determining whether reception itself is impossible due to radio wave failure, such as interfering radiowaves, shielding of radiowaves, disagreement of wireless channels (including unavailability of a vacant channel), or antenna failure, or communication or display is impossible due to disagreement of the ID code used for encryption and decoding.

By the use of the ID management method and the ID setting method proposed in Japanese Patent Applications Laid-Open Nos. H7-255089 and H11-284754 mentioned above, it is possible to set an ID code for each wireless communication system. However, since ID codes can be set freely for different wireless communication systems, when communication fails to be established within a wireless communication system, it is difficult to determine whether the cause is radio wave failure or disagreement of the ID code.

One way to make it possible to confirm disagreement of the ID code within a wireless communication system is to show in written form the value of the ID code itself on the bodies of individual appliances or in a separate document when the system is shipped. This makes it possible to check whether or not the ID code agrees. However, depending on where the ID code is shown, it may become invisible after installation or may disappear altogether. Even when the ID code is written on paper, if the paper becomes lost, the ID code can no longer be verified. Moreover, in a wireless communication system in which the ID code is verified in this way, the ID code needs to be fixed. Thus, with the wireless communication systems proposed in Japanese Patent Applications Laid-Open Nos. H7-255089 and H11-284754 mentioned above, wherein the ID code can be changed, it is not possible to verify the ID code.

### DISCLOSURE OF THE INVENTION

In view of the conventionally encountered problems discussed above, it is an object of the present invention to provide an encryption code management system that permits easy identification of a data transmitter and a data receiver that can transmit data to each other. It is another object of the present invention to provide a data processor for use in a data communication system incorporating such an encryption code management system. It is a further object of the present invention to provide an electronic apparatus for use in such a data communication system.

To achieve the above objects, according to one aspect of the present invention, an encryption code management system for use in a plurality of communication systems composed of a plurality of data processors that exchange data encrypted with specific encryption codes is configured as follows. There is provided an electronic apparatus including: a code management reception portion that receives the encryption codes of the data processors; a code management control portion that compares a plurality of the encryption codes received by the code management reception portion; and a result output portion that outputs the comparison result yielded by the code management control portion. Moreover, the data processors include a code management transmission portion that transmits the encryption codes of the data processors themselves to the electronic apparatus.

According to another aspect of the present invention, an encryption code management system for use in a plurality of communication systems composed of a plurality of data processors that exchange data encrypted with specific encryption codes is configured as follows. There is provided an electronic apparatus including: a code management reception portion that receives the encryption codes of the data processors; a code management control portion that compares a plurality of the encryption codes received by the code management reception portion; and a code management transmission portion that transmits the comparison result yielded by the code management control portion to the data processors. Moreover, the data processors include: a code management transmission portion that transmits the encryption codes of the data processors themselves to the electronic apparatus; a code management reception portion that receives the comparison result from the electronic apparatus; and a result output portion that outputs the comparison result received by the code management reception portion.

According to a further aspect of the present invention, an encryption code management system for use in a plurality of communication systems composed of a plurality of data processors that exchange data encrypted with specific encryption codes is configured as follows. There is provided an electronic apparatus including: a code management reception portion that receives the encryption codes of the data processors; a code storage portion that stores one or a plurality of the encryption codes received by the code management reception portion; and a code management transmission portion that transmits the encryption codes stored in the code storage portion to the data processors. Moreover, the data processors include: a code management transmission portion that transmits the encryption codes of the data processors themselves to the electronic apparatus; a code management reception portion that receives the encryption codes transmitted from the electronic apparatus; a code management control portion that compares the encryption codes received by the code management reception portion with the encryption codes of the data processors themselves; and a result output portion that outputs the comparison result yielded by the code management control portion.

### BRIEF DESCRIPTION OF DRAWINGS

FIG. 1 is a diagram illustrating an ID management system according to the invention;

FIG. 2 is a block diagram showing the internal configuration of an AV data transmitter according to the invention;

FIG. 3 is a block diagram showing the internal configuration of an AV data receiver according to the invention;

FIG. 4 is a block diagram showing the internal configuration of the ID administrator's remote control unit of a first embodiment of the invention;

FIG. 5 is a state transition diagram showing the transition of the states of individual devices in the ID management system of the first embodiment;

FIGS. 6A to 6D are diagrams showing the exterior appearance of the ID administrator's remote control unit of the first embodiment and examples of what is displayed thereon;

FIG. 7 is a diagram showing the exterior appearance of the ID administrator's remote control unit of a second embodiment of the invention;

FIG. 8 is a flow chart showing the operation of the ID administrator's remote control unit of the second embodiment;

FIG. 9 is a block diagram showing the internal configuration of the ID administrator's remote control unit of a third embodiment of the invention;

FIG. 10 is a flow chart showing the operation of the ID administrator's remote control unit of the third embodiment;

FIG. 11 is a flow chart showing the operation of the ID administrator's remote control unit of the third embodiment;

FIGS. 12A to 121 are diagrams showing the exterior appearance of the ID administrator's remote control unit of the third embodiment and examples of what is displayed thereon;

FIG. 13 is a block diagram showing the internal configuration of the ID administrator's remote control unit of a fourth embodiment of the invention;

FIG. 14 is a diagram showing the exterior appearance of the ID administrator's remote control unit of the fourth embodiment;

FIG. 15 is a block diagram showing an example of the relationship between AV data transmitters and AV data receivers building a plurality of AV data wireless communication systems;

FIG. 16A to 16D are diagrams showing examples of what is displayed on the ID administrator's remote control unit of the fourth embodiment;

FIG. 17 is a block diagram showing the internal configuration of the ID administrator's remote control unit of a fifth embodiment of the invention;

FIG. 18 is a diagram showing the exterior appearance of the ID administrator's remote control unit of the fifth embodiment;

FIG. 19 is a block diagram showing an example of the relationship between AV data transmitters and AV data receivers building a plurality of AV data wireless communication systems;

FIG. 20 is a diagram showing the contents stored in the ID storage portion of the ID administrator's remote control unit of the fifth embodiment;

FIG. 21 is a diagram showing an example of what is displayed on the ID administrator's remote control unit of the fifth embodiment;

FIG. 22 is a diagram showing another example of what is displayed on the ID administrator's remote control unit of the fifth embodiment;

FIG. 23 is a diagram showing another example of what is displayed on the ID administrator's remote control unit of the fifth embodiment;

FIGS. 24A and 24B are diagrams showing other examples of what is displayed on the ID administrator's remote control unit of the fifth embodiment;

FIG. 25 is a block diagram showing the internal configuration of the AV data transmitter of a sixth embodiment of the invention;

FIG. 26 is a block diagram showing the internal configuration of the AV data receiver of the sixth embodiment;

FIG. 27 is a state transition diagram showing the transition of the states of individual devices in the ID management system of the sixth embodiment;

FIG. 28 is a block diagram showing the internal configuration of another example of the AV data receiver of the sixth embodiment;

FIG. 29 is a block diagram showing the internal configuration of the AV data transmitter of a seventh embodiment of the invention;

FIG. 30 is a block diagram showing the internal configuration of the AV data receiver of the seventh embodiment;

FIG. 31 is a block diagram showing the internal configuration of the ID administrator's remote control unit of the seventh embodiment;

FIG. 32 is a state transition diagram showing the transition of the states of individual devices in the ID management system of the seventh embodiment;

FIG. 33 is a block diagram showing the internal configuration of the AV data transmitter of an eighth embodiment of the invention;

FIG. 34 is a block diagram showing the internal configuration of the AV data receiver of the eighth embodiment;

FIG. 35 is a block diagram showing the internal configuration of the ID administrator's remote control unit of the eighth embodiment;

FIG. 36 is a state transition diagram showing the transition of the states of individual devices in the ID management system of the eighth embodiment;

FIG. 37 is a diagram illustrating a conventional AV data wireless communication system;

FIG. 38 is a diagram showing the internal configuration of a conventional AV data transmitter; and

FIG. 39 is a diagram showing the internal configuration of a conventional AV data receiver.

### BEST MODE FOR CARRYING OUT THE INVENTION

### First Embodiment

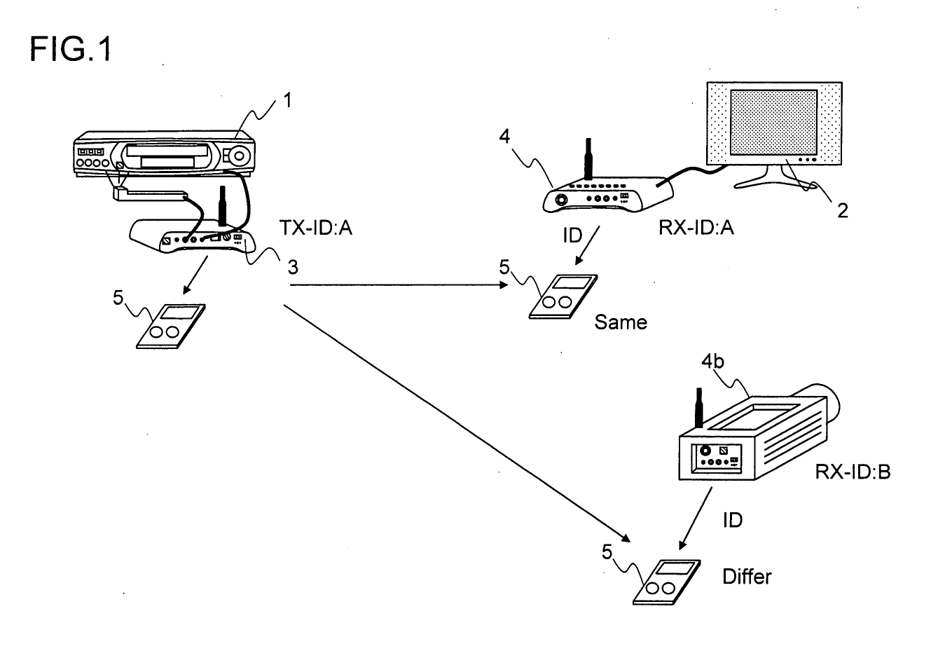

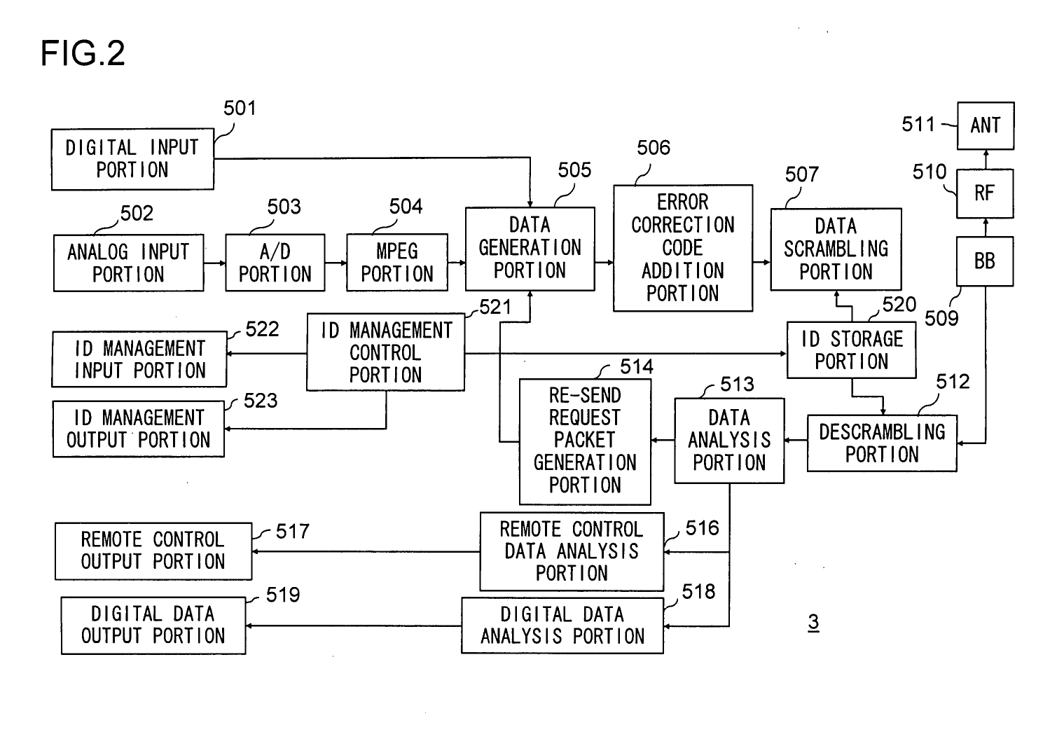

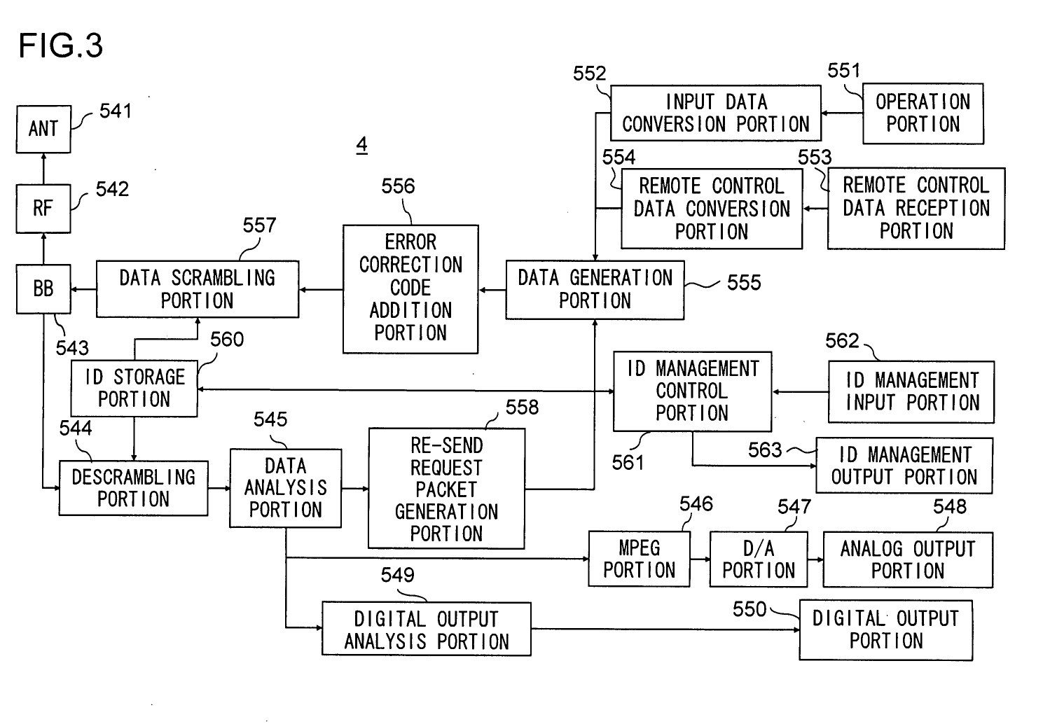

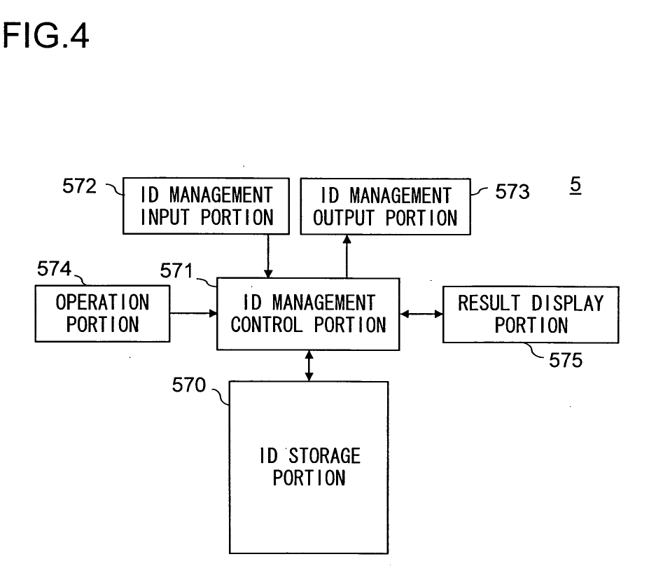

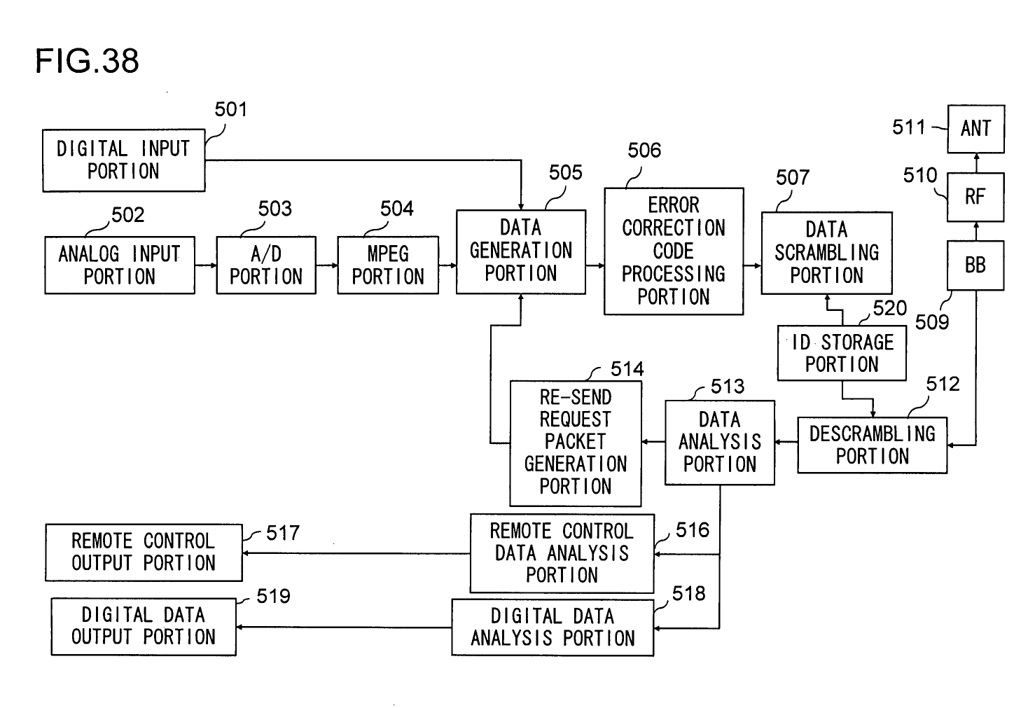

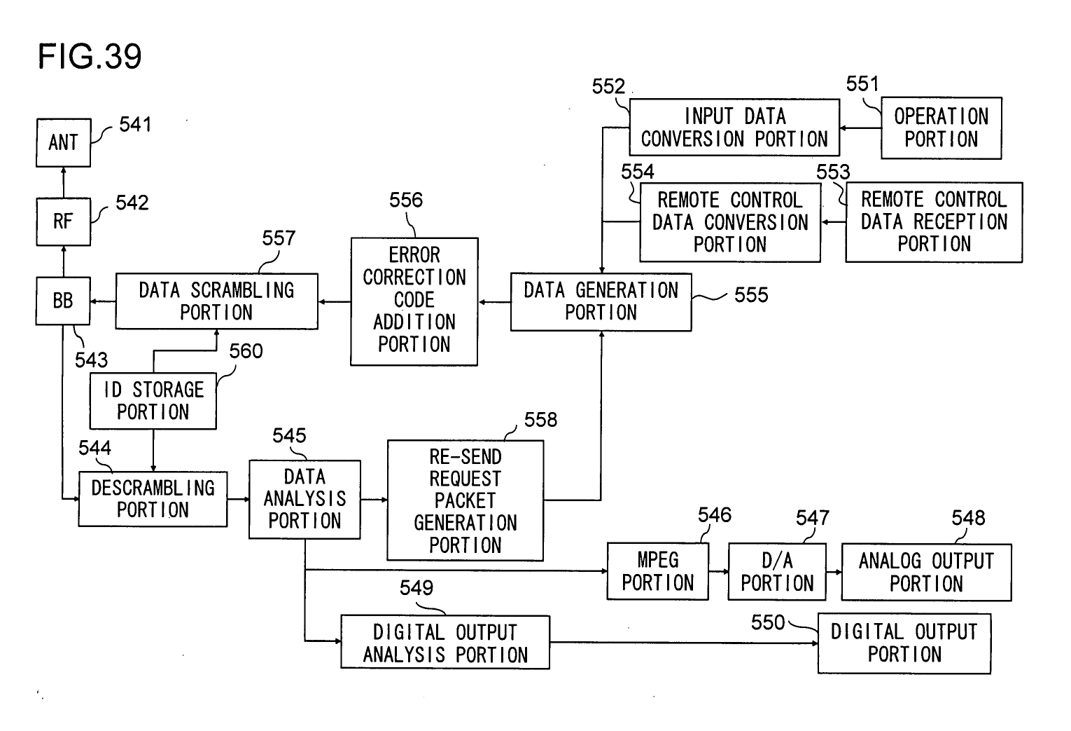

A first embodiment of the present invention will be described below with reference to the drawings. FIG. 1 is a block diagram showing the configuration of the ID management system of this embodiment. FIGS. 2 and 3 are block diagrams showing the internal configurations of an AV data transmitter and an AV data receiver. In FIGS. 2 and 3, such blocks as are found also in FIGS. 38 and 39 are identified with common reference numerals, and their detailed explanations will not be repeated. FIG. 4 is a block diagram showing the internal configuration of an ID administrator's remote control unit.

The ID management system shown in FIG. 1 is built with: an AV data transmitter 3 that is cable-connected to an AV source appliance 1; an AV data receiver 4a that is cable-connected to an AV reproduction appliance 2; an AV data receiver 4b that incorporates AV reproducing capabilities; and an ID administrator's remote control unit (remote commander) 5 that conducts infrared communication with the AV data transmitter 3 and the AV data receivers 4a and 4b. Here, the AV data transmitter 3 is assigned an ID code “A” as an ID code for AV data transmission, and the AV data receivers 4a and 4b are assigned ID codes “A” and “B”, respectively, as ID codes for AV data reception.

As shown in FIG. 2, in this embodiment, the AV data transmitter 3, as compared with the AV data transmitter shown in FIG. 38, is additionally provided with: a ID management control portion 521 that reads out the ID code recorded in the ID storage portion 520; an ID management input portion 522 that receives signals transmitted from an externally provided ID administrator's remote control unit 5; and an ID management output portion 523 that transmits the ID code recorded in the ID storage portion 520 to the externally provided ID administrator's remote control unit 5.

As shown in FIG. 3, in this embodiment, the AV data receivers 4a and 4b, as compared with the AV data receiver shown in FIG. 39, is each additionally provided with: an ID management control portion 561 that reads out the ID code recorded in the ID storage portion 560; an ID management input portion 562 that receives signals transmitted from an externally provided ID administrator's remote control unit 5; and an ID management output portion 563 that transmits the ID code recorded in the ID storage portion 560 to the externally provided ID administrator's remote control unit 5. The AV data receiver 4b shown in FIG. 1 incorporates the function of an AV reproduction appliance, and thus incorporates AV data reproducing capabilities instead of being provided with the analog output portion 548 and the digital output portion 550.

As shown in FIG. 4, in this embodiment, the ID administrator's remote control unit 5 is provided with: an ID storage portion 570 in which a received ID code is stored; an ID management control portion 571 that compares an internally recorded ID code with an externally received ID code; an ID management input portion 572 that sends out a received ID code to the ID management control portion 571; an ID management output portion 573 that sends out a signal for requesting transmission of an ID code; an operation portion 574 via which entry of an operation is accepted; and a result display portion 575 that displays the result of the comparison of IDs.

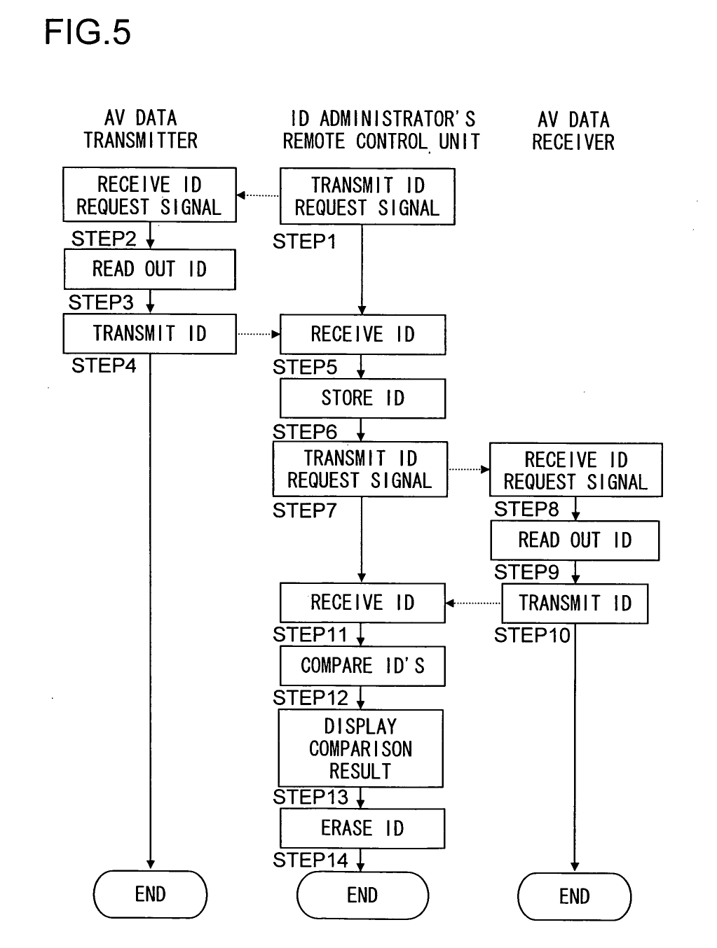

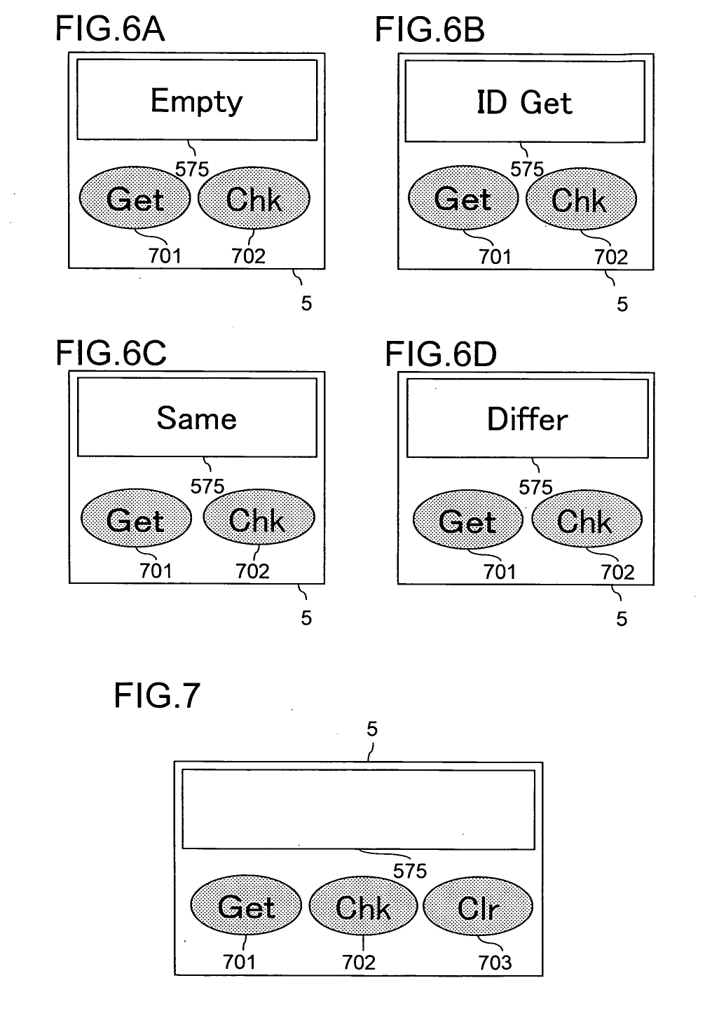

Now, the ID code verification operation performed in the AV data wireless communication system configured as described above will be described with reference to the state transition diagram shown in FIG. 5 and the examples of display shown in FIGS. 6A to 6D. As shown in FIG. 6, the ID administrator's remote control unit 5 used in this AV data wireless communication system is provided with, as the operation portion 574 thereof: a Get key 701 that is operated to request the recording of a received ID code; and a Chk key 702 that is operated to request the comparison of the received ID code with the recorded ID code.

First, in an initial state, as shown in FIG. 6A, “Empty” is displayed on the result display portion 575 to indicate that no ID code is stored in the ID storage portion 570. In this state, when the Get key 701 is operated in the range within which communication with the AV data transmitter 3 is possible, the ID management control portion 571 generates, with a view to receiving the ID code assigned to the AV data transmitter 3, an ID request signal for requesting the transmission of the ID code, and transmits the ID request signal via the ID management output portion 573 to the AV data transmitter 3 (STEP 1).

When the ID request signal is transmitted from the ID administrator's remote control unit 5 in this way, the AV data transmitter 3 receives the ID request signal via the ID management input portion 522, and the ID management control portion 521 recognizes that the ID administrator's remote control unit 5 is requesting the transmission of the ID code (STEP 2). Now, the ID code to be transmitted that is stored in the ID storage portion 520 is read out by the ID management control portion 521 (STEP 3), and is then transmitted from the ID management output portion 523 (STEP 4).

When this ID code transmitted from the AV data transmitter 3 is received by the ID management input portion 572 of the ID administrator's remote control unit 5, the ID management control portion 571 recognizes that the ID code from the AV data transmitter 3 has been received (STEP 5), and this ID code is written to the ID storage portion 570 (STEP 6). Now, to notify the result display portion 575 that the ID management control portion 571 has stored the ID code in the ID storage portion 570, as shown in FIG. 6B, “ID Get” is displayed on the result display portion 575 to indicate that the ID code has been stored.

While the ID administrator's remote control unit 5, thus having the ID code of the AV data transmitter 3 stored therein, is located in the range within which communication with any AV data receiver 4 (corresponding to the AV data receivers 4a and 4b shown in FIG. 1) is possible, when the Chk key 702 of the ID administrator's remote control unit 5 is operated, through an operation similar to that performed in STEP 1, an ID request signal is transmitted to the AV data receiver 4 (STEP 7). Then, through operations similar to those performed by the AV data transmitter 3 in STEP 2 to STEP 4, the AV data receiver 4 receives the ID request signal via the ID management input portion 562, and the ID management control portion 561 recognizes it (STEP 8). Now, the ID code is read out from the ID storage portion 560 (STEP 9), and this ID code is transmitted from the ID management output portion 563 (STEP 10).

When this ID code transmitted from the AV data receiver 4 is received by the ID management input portion 572 of the ID administrator's remote control unit 5, the ID management control portion 571 recognizes that the ID code from the AV data receiver 4 has been received (STEP 11). The ID management control portion 571 then reads out the ID code of the AV data transmitter 3 stored in the ID storage portion 570, and compares the ID code of the AV data transmitter 3 with the ID code of the AV data receiver 4 (STEP 12).

After this comparison between the ID code of the AV data transmitter 3 and the ID code of the AV data receiver 4, the ID management control portion 571 notifies the result display portion 575 of the result of the comparison, and thus the result of the comparison is displayed on the result display portion 575 (STEP 13). The ID management control portion 571 then erases the ID code of the AV data transmitter 3 stored in the ID storage portion 570 (STEP 14).

Specifically, in the configuration shown in FIG. 1, when the ID code “A” of the AV data transmitter 3 is recorded in the ID administrator's remote control unit 5, and is compared with the ID code “A” of the AV data receiver 4a, then, as shown in FIG. 6C, “Same” is displayed on the result display portion 575 to indicate that the ID codes coincide. By contrast, when the ID code “A” of the AV data transmitter 3 is recorded in the ID administrator's remote control unit 5, and is compared with the ID code “B” of the AV data receiver 4b, then, as shown in FIG. 6D, “Differ” is displayed on the result display portion 575 to indicate that the ID codes are different.

In this way, by checking with the ID administrator's remote control unit 5 whether or not the ID codes of the AV data transmitter 3 and the AV data receiver 4 that are selected coincide, it is possible to check whether or not the AV data transmitter 3 and the AV data receiver 4 that are selected build an AV data wireless communication system. In the example shown in FIG. 5, the ID administrator's remote control unit 5 is assumed to first record the ID code of the AV data transmitter 3 and then compare it with the ID code of the AV data receiver 4. The same checking can be achieved also by making the ID administrator's remote control unit 5 first record the ID code of the AV data receiver 4 and then compare it with the ID code of the AV data transmitter 3. This can be achieved through operations similar to those described above.

The operation portion 574 is here assumed to be composed of two keys, namely the Get key 701 and the Chk key 702, but may alternatively be composed of a single key. In that case, when the key is operated for the first time while the ID storage portion 570 is still empty with no ID code recorded therein, the received ID code is stored in the ID storage portion 570 (STEP 1, STEP 5, and STEP 6). Then, when the key is operated for the second time, the received ID code is compared with the ID code recorded in the ID storage portion 570, then the result of the comparison is displayed on the result display portion 575, and then the ID storage portion 570 is emptied by erasing the ID code recorded therein (STEP 7, and STEP 11 to STEP 14).

### Second Embodiment

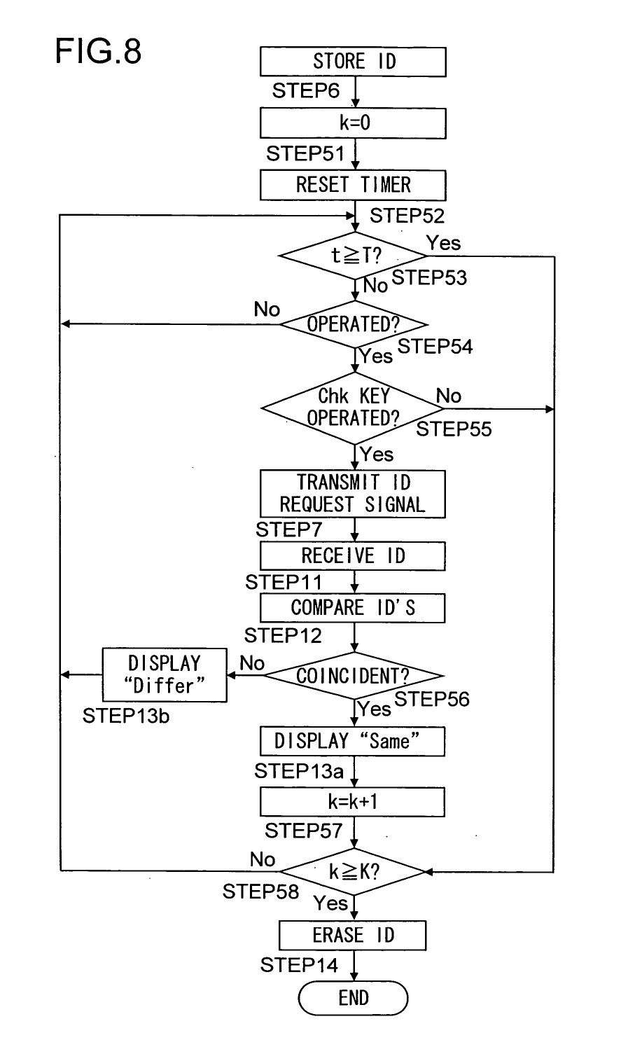

A second embodiment of the present invention will be described below with reference to the drawings. In the AV data wireless communication system of this embodiment, the internal configurations of an AV data transmitter 3, an AV data receiver 4, and an ID administrator's remote control unit 5 are the same as in the first embodiment, i.e., as shown in FIGS. 2 to 4. FIG. 7 is an exterior view showing the configuration of the ID administrator's remote control unit 5 in this embodiment. In FIG. 7, such parts as are found also in FIG. 6 are identified with common reference numerals, and their detailed explanations will not be repeated. FIG. 8 is a flow chart illustrating the ID code storage operation performed by the ID administrator's remote control unit 5.

In this embodiment, the AV data transmitter 3 and the AV data receiver 4 operate in manners similar to how they operate in the first embodiment. In those regards, therefore, no detailed explanations will be repeated below, but those given earlier in connection with the first embodiment are to be referred to. The following description thus concentrates on how the ID administrator's remote control unit 5 operates. As shown in FIG. 7, the ID administrator's remote control unit 5 is provided with, as the operation portion 574, in addition to a Get key 701 and a Chk key 702, a Clr key 703 that is operated to request the erasing of the ID code stored in the ID storage portion 570. In other respects, the ID administrator's remote control unit 5 has the same configuration as in the first embodiment.

Now, how the ID administrator's remote control unit 5 operates after an ID code is stored in the ID storage portion 570 will be described with reference to the flow chart shown in FIG. 8. As in the first embodiment, as shown in FIG. 5, when the ID administrator's remote control unit 5, after transmitting an ID request signal, receives the ID code from the AV data transmitter 3, the ID code of the AV data transmitter 3 is stored in the ID storage portion 570 (STEP 6). When the ID code is stored in this way, the ID management control portion 571 resets to zero the number of times k that ID code coincidence has been found (STEP 51), and then resets the measurement duration t to zero by resetting a timer that counts the lapse of time after the ID code is stored (STEP 52). The timer is provided in the ID management control portion 571.

Thereafter, the ID management control portion 571 first checks whether or not the measurement duration t counted by the timer has exceeded a predetermined duration T (STEP 53). If the predetermined duration T has not yet been exceeded (No), then whether or not the operation portion 574 has been operated is checked (STEP 54). If the operation portion 574 has been operated (Yes), the ID management control portion 571 then checks whether or not the Chk key 702 has been operated (STEP 55). If the Chk key 702 has been operated (Yes), as in the first embodiment, first an ID request signal is transmitted to the AV data receiver 4, then the ID code of the AV data receiver 4 is received, and then this ID code is compared with the ID code of the AV data transmitter 3 stored in the ID storage portion 570 (STEP 7, STEP 11, and STEP 12).

Then, whether or not the ID codes of the AV data transmitter 3 and the AV data receiver 4 coincide is checked (STEP 56). If the ID codes coincide (Yes), “Same” is displayed on the result display portion 575 (STEP 13a); if the ID codes do not coincide (No), “Differ” is displayed on the result display portion 575 (STEP 13b). When the flow proceeds to STEP 13a to display “Same”, the ID management control portion 571 increments by one the number of times k that ID code coincidence has been found (STEP 57), and checks whether or not this number of times k has exceeded the predetermined number of times K (STEP 58). That is, this predetermined number of times K represents the number of AV data receivers 4 that have been permitted to communicate with the AV data transmitter 3, and thus up to K AV data receivers 4 are permitted to communicate with one AV data transmitter.

If, in STEP 54, the operation portion 574 has not been operated (No), or if, in STEP 13b, “Differ” is displayed, or if, in STEP 58, the number of AV data receivers 4 of which the ID code has been found coincident has not yet exceeded K (No), the flow proceeds to STEP 53 to check whether or not the predetermined duration T has elapsed after the ID code was stored. If, in STEP 53, the predetermined duration T is found to have elapsed (Yes), or if, in STEP 55, the Clr key 703 has been operated (No), or if, in STEP 58, the number of AV data receivers 4 of which the ID code has been found coincident has exceeded K (Yes), the flow proceeds to STEP 14 to erase the ID code of the AV data transmitter 3 stored in the ID storage portion 570.

Through this sequence of operations, ID codes can be verified in an AV data wireless communication system where a plurality of AV data receivers 4 are permitted to communicate with an AV data transmitter 3. Here, enhanced security is achieved by permitting the ID storage portion 570 to store IDs until the end of a predetermined duration or until the number of AV data receivers of which the ID code coincides reaches the upper limit. In this embodiment, the Clr key 703 is assumed to be provided, but instead it is possible to erase an ID code when, after one is stored, the Get key 701 is operated. In STEP 55 in FIG. 8, when the Get key 701 is operated, an error message may be displayed on the result display portion 575.

### Third Embodiment

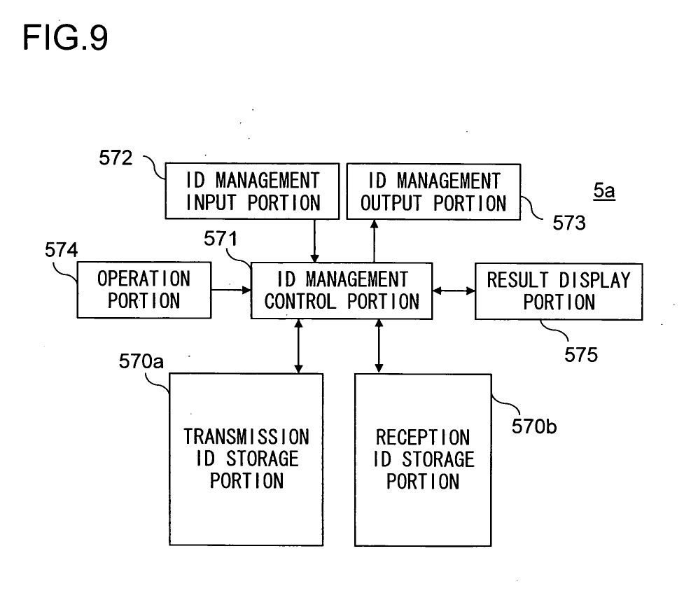

A third embodiment of the present invention will be described below with reference to the drawings. In the AV data wireless communication system of this embodiment, the internal configurations of an AV data transmitter 3 and an AV data receiver 4 are the same as in the first embodiment, i.e., as shown in FIGS. 2 and 3. FIG. 9 is a block diagram showing the internal configuration of an ID administrator's remote control unit 5a in this embodiment. In FIG. 9, such blocks as are found also in FIG. 4 are identified with common reference numerals, and their detailed explanations will not be repeated.

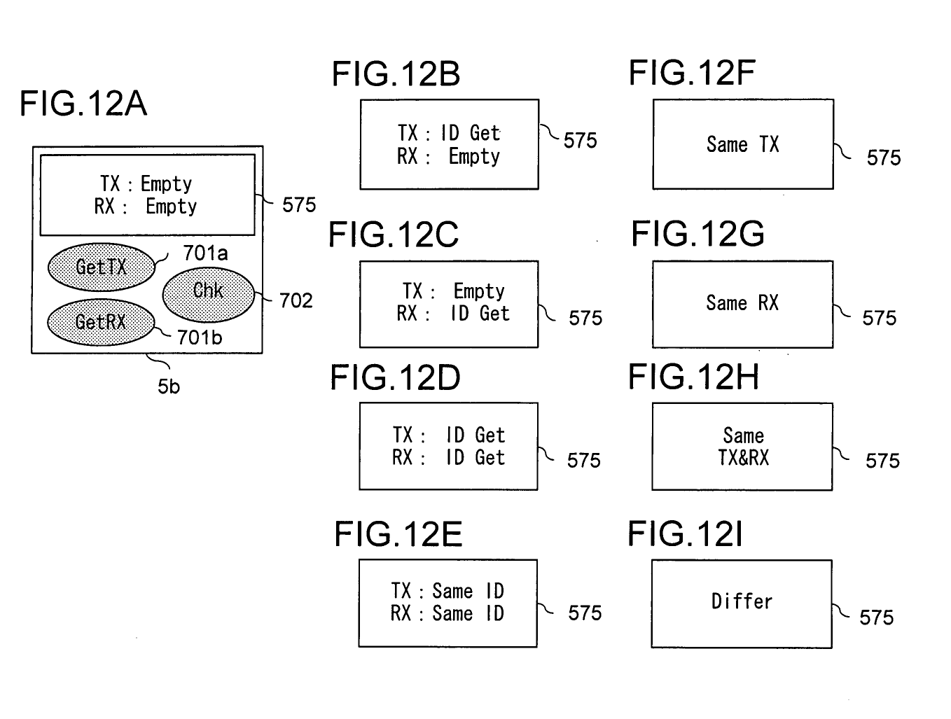

The ID administrator's remote control unit 5a shown in FIG. 9 is provided with, instead of the ID storage portion 570 provided in the ID administrator's remote control unit 5 shown in FIG. 5, a transmission ID storage portion 570a and a reception ID storage portion 570b. That is, the ID administrator's remote control unit 5a can store the transmission ID code of the AV data transmitter 3 and the reception ID code of the AV data receiver 4. Moreover, as shown in FIG. 12A, the ID administrator's remote control unit 5a is provided with, as the operation portion 574, a GetTX key 701a for acquiring the transmission ID code, a GetRX key 701b for acquiring the transmission ID code, and a Chk key 702.

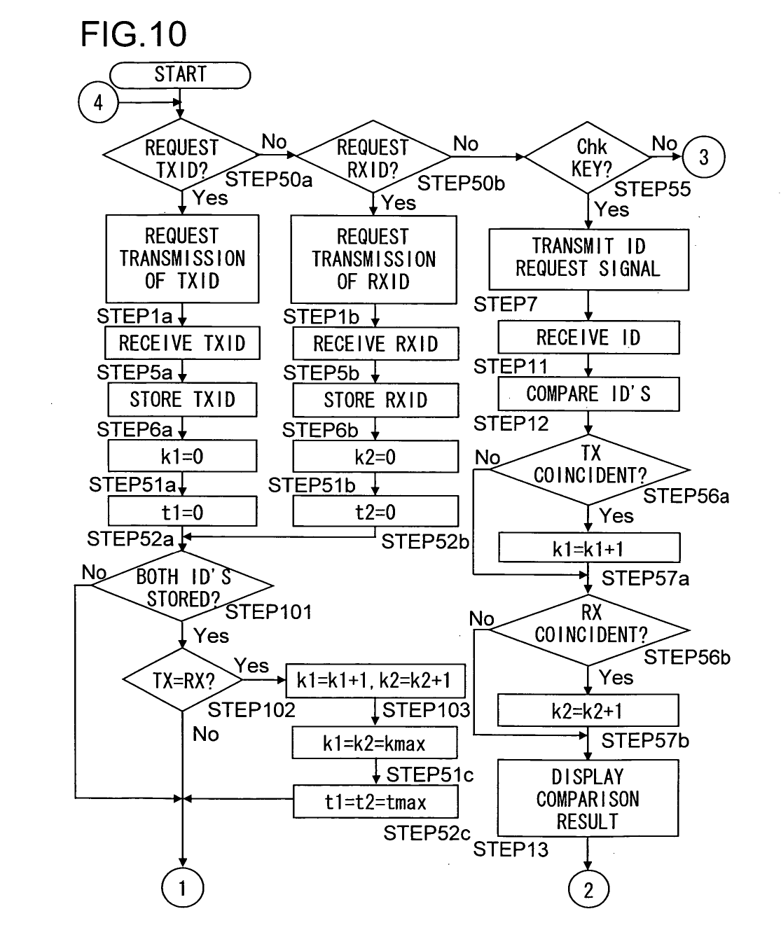

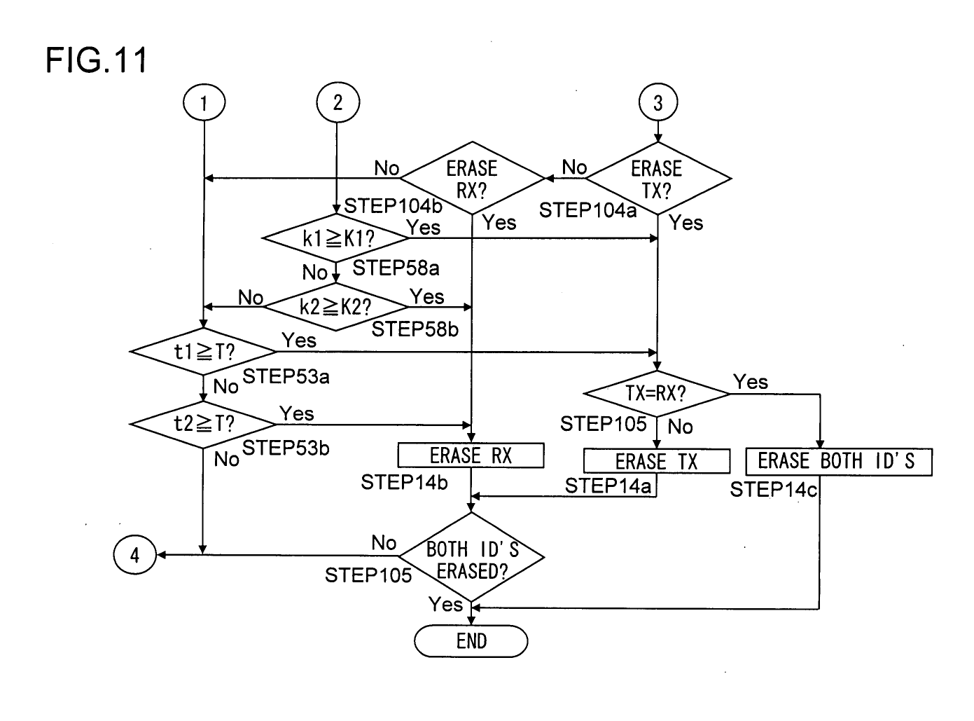

Now, the operation of this ID administrator's remote control unit 5a will be described with reference to the flow charts shown in FIGS. 10 and 11. First, in the ID administrator's remote control unit 5a, the ID management control portion 571 checks whether or not the GetTX key 701a in the operation portion 574 has been operated to request the acquisition of the transmission ID code of the AV data transmitter 3 (STEP 50a). If the GetTX key 701a has been operated (Yes), a TXID request signal for requesting the transmission of the transmission ID code of the AV data transmitter 3 is generated by the ID management control portion 571, and is transmitted from the ID management output portion 573 (STEP 1a).

When the ID management input portion 572 receives the transmission ID code of the AV data transmitter 3 (STEP 5a), the ID management control portion 571 stores the received transmission ID code in the transmission ID storage portion 570a (STEP 6a). Thereafter, the ID management control portion 571 initializes, by resetting to zero, the number of times k1 that coincidence with the transmission ID code has been found (STEP 51a), and resets a timer for counting the lapse of time t1 after the storage in the transmission ID storage portion 570a (STEP 52a).

If, in STEP 50a, the GetTX key 701a is found not to have been operated (No), whether or not the GetRX key 701b has been operated to request the acquisition of the reception ID code of the AV data receiver 4 is checked (STEP 50b). When the GetRX key 701b has been operated (Yes), an RXID request signal for requesting the transmission of the reception ID code of the AV data receiver 4 is transmitted (STEP 1b). When the reception ID code of the AV data receiver 4 is received (STEP 5b), it is stored in the reception ID storage portion 570b (STEP 6b). Thereafter, the number of times k2 that coincidence with the reception ID code has been found is initialized by being reset to zero (STEP 51b), and a timer for counting the lapse of time t2 after the storage in the reception ID storage portion 570b is reset (STEP 52b).

After the timer for measuring the measurement duration t1 or t2 is reset in STEP 52a or 52b in this way, whether or not ID codes have been stored in both the transmission ID storage portion 570a and the reception ID storage portion 570b is checked (STEP 101). If a transmission ID code and a reception ID code are stored in the transmission ID storage portion 570a and the reception ID storage portion 570b, respectively (Yes), then the ID management control portion 571 checks whether or not the transmission ID code and the reception ID code coincide (STEP 102).

If the transmission ID code and the reception ID code coincide (Yes), the transmission ID code and the reception ID code stored in the transmission ID storage portion 570a and the reception ID storage portion 570b, respectively, are recognized to belong to the same AV data wireless communication system, and thus the numbers of times k1 and k2 that coincidence with the transmission ID code and the reception ID code, respectively, have been found are each incremented by one (STEP 103). Then, of these incremented numbers of times k1 and k2, the greater kmax is chosen, and the numbers of times k1 and k2 are both set to the chosen value kmax so as to be equal to each other (STEP 51c). Likewise, of the measurement durations t1 and t2, the longer tmax is chosen, and the measurement durations t1 and t2 are both set to the chosen value tmax so as to be equal to each other (STEP 52c).

If, in STEP 50b, the GetRX key,701b is found not to have been operated (No), whether or not the Chk key 702 of the operation portion 574 has been operated to request the verification of the ID code of the AV data transmitter 3 or the AV data receiver 4 is checked (STEP 55). If the Chk key 702 has been operated (Yes), as in the second embodiment, an ID request signal for requesting the transmission of the ID code is transmitted to any AV data transmitter 3 or AV data receiver 4 of which the ID code is to be verified (STEP 7). When the ID code is received (STEP 11), the received ID code is compared with each of those stored in the transmission ID storage portion 570a and the reception ID storage portion 570b to check for coincidence between them (STEP 12).

Based on the result of the comparison in STEP 12, whether or not the received ID code coincides with the transmission ID code in the transmission ID storage portion 570a is checked (STEP 56a). If coincidence with the transmission ID code is found (Yes), the number of time k1 is incremented by one (STEP 57a). When an increment is added in STEP 57a, or if coincidence with the transmission ID code is not found (No), then, based on the result of the comparison in STEP 12, whether or not the received ID code coincides with the reception ID code in the reception ID storage portion 570b is checked (STEP 56b). If coincidence with the reception ID code is found (Yes), the number of time k2 is incremented by one (STEP 57b).

Thereafter, the result of the comparison in STEP 12 is fed to the result display portion 575 to make it display the comparison result (STEP 13). Here, different indications are displayed in the following different cases: (1) coincidence has been found only with the transmission ID code in the transmission ID storage portion 570a; (2) coincidence has been found only with the reception ID code in the reception ID storage portion 570b; (3) coincidence has been found both between the transmission ID code and reception ID code in the transmission ID storage portion 570a and the reception ID storage portion 570b and between these ID codes and the received ID code; and (4) no coincidence has been found with either of the transmission ID code and the reception ID code in the transmission ID storage portion 570a and the reception ID storage portion 570b.

After the result of the comparison is displayed in this way, whether or not the number of times k1 that coincidence with the transmission ID code in the transmission ID storage portion 570a has been found has become greater than or equal to K1 is checked (STEP 58a). If the number of times k1 that coincidence with the transmission ID code has been found is smaller than the predetermined number K1 (No), whether or not the number of times k2 that coincidence with the reception ID code in the reception ID storage portion 570b has been found has become greater than or equal to K2 is checked (STEP 58b).

If, in STEP 55, the Chk key 702 is found not to have been operated (No), whether or not the GetTX key 701a has been operated to erase the transmission ID code in the transmission ID storage portion 570a is checked (STEP 104a). Then, if the GetTX key 701a is found not to have been operated (No), whether or not the GetRX key 701b has been operated to erase the reception ID code in the reception ID storage portion 570b is checked (STEP 104b).

If, in STEP 52c, the measurement durations t1 and t2 are made equal, or if, in STEP 101, only either a transmission ID code or a reception ID code has been stored (No), or if, in STEP 102, the stored transmission ID code and reception ID code do not coincide (No), or if, in STEP 58b, the number of times k2 that coincidence with the reception ID code has been found is smaller than the predetermined number K2 (No), or if, in STEP 104a, the GetRX key 701b has not been operated (No), then whether or not the measurement duration t1 after the transmission ID code was stored has become longer than or equal to a predetermined duration T is checked (STEP 53a). If the measurement duration t1 has not exceeded the predetermined duration T (No), then whether or not the measurement duration t2 after the reception ID code was stored has become longer than or equal to the predetermined duration T is checked (STEP 53b).

If, in STEP 53a, the measurement duration t1 is longer than or equal to the predetermined duration T (Yes), or if, in STEP 58a, the number of times k1 that coincidence with the transmission ID code has been found is greater than or equal to the predetermined number K1 (Yes), or if, in STEP 104a, or if, in STEP 104a, the GetTX key 701a has been operated (Yes), then whether or not the transmission ID code in the transmission ID storage portion 570a and the reception ID code in the reception ID storage portion 570b coincide is checked (STEP 105). Here, if the two ID codes do not coincide (No), the transmission ID code stored in the transmission ID storage portion 570a is erased (STEP 14a). Moreover, if, in STEP 53b, the measurement duration t2 is longer than ore equal to the predetermined duration T (Yes), or if, in STEP 58b, the number of times k2 that coincidence with the reception ID code has been found is greater than or equal to the predetermined number K2 (Yes), or if, in STEP 104b, the GetRX key 701b has been operated (Yes), then the transmission ID code stored in the reception ID storage portion 570b is erased (STEP 14b).

When the transmission ID code is erased in STEP 14a or the reception ID code is erased in STEP 14b, then whether or not both the transmission ID storage portion 570a and the reception ID storage portion 570b are empty is checked (STEP 105). That is, whether or not both the transmission ID code and the reception ID code have been erased is checked. If an ID code is stored in either of the transmission ID storage portion 570a and the reception ID storage portion 570b (No), then the flow proceeds to STEP 50a so that the operations in STEP 50a and the following steps are performed once again. If the ID codes have been erased from both the transmission ID storage portion 570a and the reception ID storage portion 570b (Yes), the flow ends. If, in STEP 105, the transmission ID code and the reception ID code coincide (Yes), the ID codes are erased from both the transmission ID storage portion 570a and the reception ID storage portion 570b (STEP 14c), and the flow ends.

As the ID administrator's remote control unit 5a operates according to the above-described flow, from one operation state thereof to another, what is displayed on the result display portion 575 changes as shown in FIGS. 12B to 121. Specifically, first, when neither a transmission ID code or a reception ID code has been stored yet, as shown in FIG. 12A, the result display portion 575 displays: “TX: Empty; RX: Empty”. Here “TX” indicates the recording state of the transmission ID code, and “RX” indicates the recording state of the reception ID code.

When the GetTX key 701a is operated and a transmission ID code is stored in the transmission ID storage portion 570a, then, as shown in FIG. 12B, the result display portion 575 displays: “TX: ID Get; RX: Empty”. On the other hand, when the GetRX key 701b is operated and a reception ID code is stored in the reception ID storage portion 570b, then, as shown in FIG. 12C, the result display portion 575 displays: “TX: Empty; RX:” ID Get.

Thus, for example, in the AV data wireless communication system shown in FIG. 1, when the GetTX key 701 a is operated in the range within which communication with the AV data transmitter 3 is possible, the ID code “A” is stored in the transmission ID storage portion 570a, and the display shown in FIG. 12B appears. On the other hand, when the GetRX key 701b is operated in the range within which communication with the AV data receiver 4a is possible, the ID code “A” is stored in the reception ID storage portion 570b, and the display shown in FIG. 12C appears. Likewise, when the GetRX key 701b is operated in the range within which communication with the AV data receiver 4b is possible, the ID code “B” is stored in the reception ID storage portion 570b, and the display shown in FIG. 12C appears.

In the state where the display as shown in FIG. 12B is present, if the GetRX key 701b is operated and a reception ID code is acquired, or, in the state where the display as shown in FIG. 12C is present, if the GetTX key 701a is operated and a transmission ID code is acquired, now a transmission ID code and a reception ID code are stored in the transmission ID storage portion 570a and the reception ID storage portion 570b, respectively, and thus, as shown in FIG. 12D, the result display portion 575 displays “TX: ID Get; RX: ID Get”. Here, if the transmission ID code and the reception ID code stored in the transmission ID storage portion 570a and the reception ID storage portion 570b, respectively, coincide, then, as shown in FIG. 12E, the result display portion 575 displays “TX: Same ID; RX: Same ID”.

Thus, for example, in the AV data wireless communication system shown in FIG. 1, when the ID code “A” is stored in the transmission ID storage portion 570a, if the GetRX key 701b is operated in the range within which communication with the AV data receiver 4b is possible, the ID code “B” is stored in the reception ID storage portion 570b, and the display shown in FIG. 12D appears. Likewise, when the ID code “B” is stored in the reception ID storage portion 570b, if the GetTX key 701a is operated in the range within which communication with the AV data transmitter 3 is possible, the display shown in FIG. 12D appears. If communication is conducted with both the AV data transmitter 3 and the AV data receiver 4a and the ID code “A” is stored in both the transmission ID storage portion 570a and the reception ID storage portion 570b, the display shown in FIG. 12E appears.

In the state where the display as shown in FIG. 12B or 12D is present, if the Chk key 702 is operated and the ID code received from any AV data transmitter 3 or AV data receiver 4 coincides with the transmission ID code stored in the transmission ID storage portion 570a, then, as shown in FIG. 12F, the result display portion 575 displays “Same TX” to indicate that the received ID code coincides with the transmission ID code. In the state where the display as shown in FIG. 12C or 12D is present, if the Chk key 702 is operated and the ID code received from any AV data transmitter 3 or AV data receiver 4 coincides with the reception ID code stored in the reception ID storage portion 570b, then, as shown in FIG. 12G, the result display portion 575 displays “Same RX” to indicate that the received ID code coincides with the reception ID code.

In the state where the display as shown in FIG. 12E is present, if the Chk key 702 is operated and the ID code received from any AV data transmitter 3 or AV data receiver 4 coincides with both the IDs stored respectively in the transmission ID storage portion 570a and the reception ID storage portion 570b, then, as shown in FIG. 12H, the result display portion 575 displays “Same TX & RX” to indicate that the received ID code coincides with both the transmission ID code and the reception ID code.

In the state where the display as shown in one of FIGS. 12B to 12E is present, if the Chk key 702 is operated and the ID code received from any AV data transmitter 3 or AV data receiver 4 does not coincide with either of the transmission ID code stored in the transmission ID storage portion 570a and the reception ID code of the reception ID storage portion 570b, then, as shown in FIG. 121, the result display portion 575 displays “Differ” to indicate that the received ID code does not coincide with either of the stored ID codes.

Thus, for example, in the AV data wireless communication system shown in FIG. 1, when the ID code “A” is stored in the transmission ID storage portion 570a, if the Chk key 702 is operated in the range within which communication with the AV data receiver 4a is possible, the ID code “A” is received, and, since this coincides with the transmission ID code “A” in the transmission ID storage portion 570a, the display shown in FIG. 12F appears. When the ID code “A” is stored in the reception ID storage portion 570b, if the Chk key 702 is operated within the region in which communication with the AV data transmitter 3 or the AV data receiver 4a is possible, the ID code “A” is received, and, since this coincides with the reception ID code “A” in the reception ID storage portion 570b, the display shown in FIG. 12G appears.

When the ID code “A” is stored in the transmission ID storage portion 570a and the reception ID storage portion 570b, if the Chk key 702 is operated in the range within which communication with the AV data receiver 4a is possible, the ID code “A” is received, and, since this coincides with both the transmission ID code “A” in the transmission ID storage portion 570a and the reception ID code “A” in the reception ID storage portion 570b, the display shown in FIG. 12H appears. When the ID code “A” is stored in the transmission ID storage portion 570a and the reception ID storage portion 570b, if the Chk key 702 is operated in the range within which communication with the AV data receiver 4b is possible, the ID code “B” is received, and, since this does not coincide with either of the transmission ID code “A” in the transmission ID storage portion 570a and the reception ID code “A” in the reception ID storage portion 570b, the display shown in FIG. 121 appears.

As described above, this embodiment permits devices whose ID codes are coincident to be identified even in an AV data wireless communication system in which a single AV data transmitter 3 is permitted to communicate with a plurality of AV data receivers 4. In a case where different transmission and reception ID codes are stored, devices belonging to AV data wireless communication systems that use each of those IDs can be identified. Moreover, by making the ID administrator's remote control unit 5a operate as shown in the flow charts shown in FIGS. 10 and 11, it is possible to erase the stored ID codes after the lapse of a predetermined period of time, in response to an operation by the user, or based on the upper limit of the number of devices with which communication is permitted.

### Fourth Embodiment

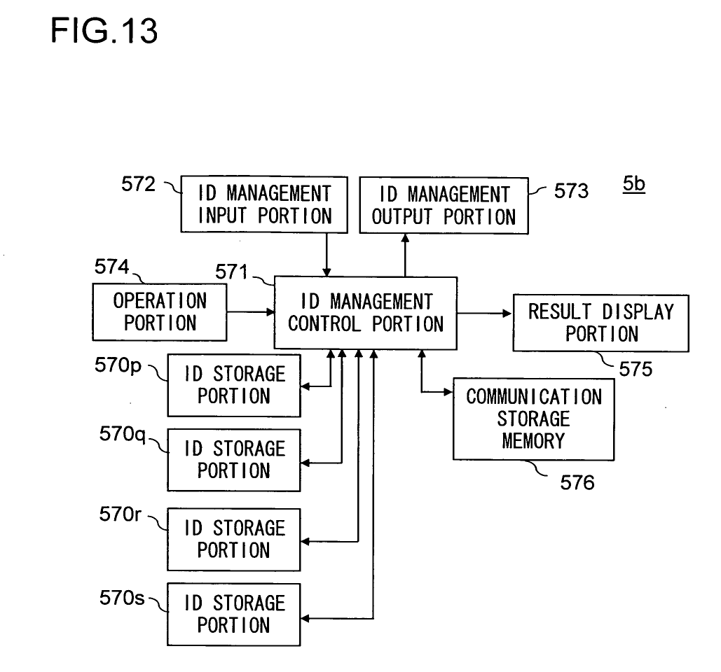

A fourth embodiment of the present invention will be described below with reference to the drawings. In the AV data wireless communication system of this embodiment, the internal configurations of an AV data transmitter 3 and an AV data receiver 4 are the same as in the first embodiment, i.e., as shown in FIGS. 2 and 3. FIG. 13 is a block diagram showing the internal configuration of an ID administrator's remote control unit 5b in this embodiment. In FIG. 13, such blocks as are found also in FIG. 4 are identified with common reference numerals, and their detailed explanations will not be repeated.

The ID administrator's remote control unit 5b shown in FIG. 13 is provided with, instead of the ID storage portion 570 provided in the ID administrator's remote control unit 5 shown in FIG. 5, four ID storage portions 570p to 570s, and is additionally provided with a communication storage memory 576 in which is stored the relationship among the ID codes stored in the ID storage portions 570p to 570s. That is, the ID administrator's remote control unit 5b can store a plurality of ID codes that are assigned to AV data transmitters 3 and AV data receivers 4.

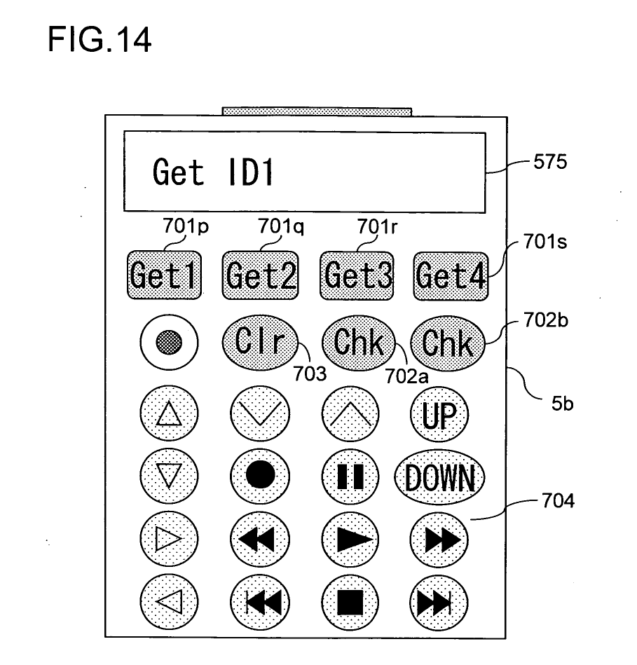

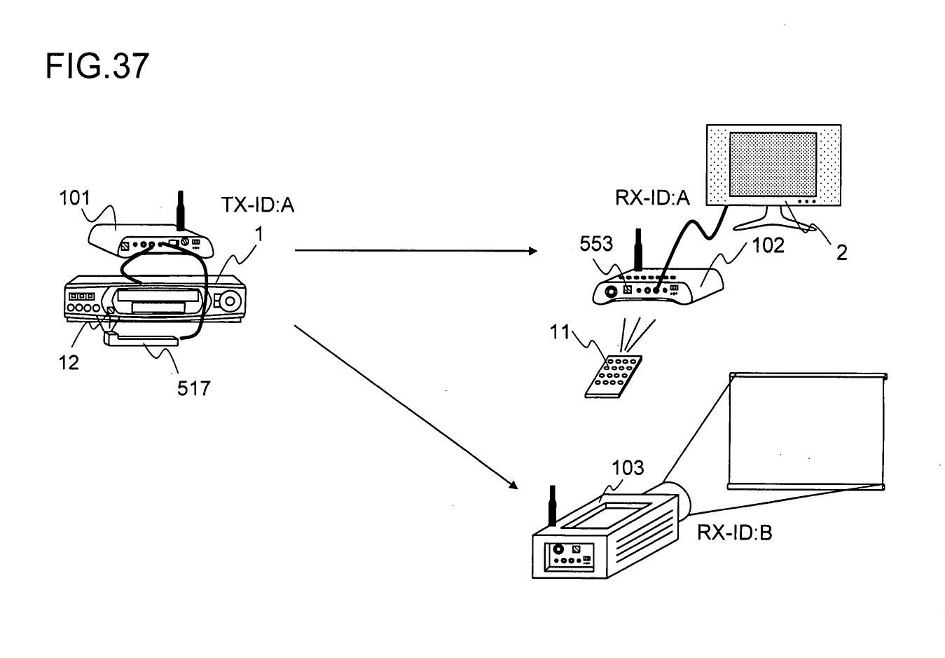

Moreover, as shown in FIG. 14, the ID administrator's remote control unit 5b is provided with, as the operation portion 574: Get keys 701p to 701s that are operated to acquire ID codes from AV data transmitters 3 and AV data receivers 4; a Chk key 702a that is operated to compare between the ID codes stored in the ID storage portions 570p to 570s; a Chk key 702b that is operated to compare with the ID codes stored in the ID storage portions 570p to 570s; a Clr key 703 that is operated to erase the ID codes stored in the ID storage portions 570p to 570s; and a key portion 704 that is provided with the same functions as the remote control unit 11 shown in FIG. 37 so as to be capable of controlling the operation of the AV source appliance 1.

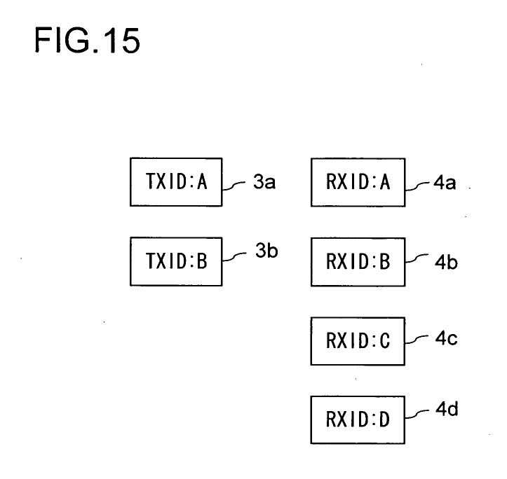

Now, the operation of the ID administrator's remote control unit 5b configured as described above will be described with reference to FIG. 15. FIG. 15 is a block diagram showing the relationship among AV data transmitters and AV data receivers that build a plurality of AV data wireless communication systems. In FIG. 15, an AV data transmitter 3a to which an ID code “A” is assigned and an AV data receiver 4a to which an ID code “A” is assigned build an AV data wireless communication system, and an AV data transmitter 3b to which an ID code “B” is assigned and an AV data receiver 4b to which an ID code “B” is assigned build an AV data wireless communication system. Also assumed to be installed in FIG. 15 are AV data receivers 4c and 4d to which ID codes “C” and “D”, respectively, are assigned.

With the AV data transmitters 3a and 3b and the AV data receivers 4a to 4d installed in the above-described relationship, when the Get key 701p of the ID administrator's remote control unit 5b is operated in the range within which communication is possible with the AV data transmitter 3a, the ID management output portion 573 transmits an ID request signal to the AV data transmitter 3a. Thus, the AV data transmitter 3a transmits the ID code “A” back, and this ID code “A” is received by the ID management input portion 572. Here, the ID management control portion 571 controls the write operation so that the ID code “A” is stored in the ID storage portion 570p, which is supposed to be used as a storage when the Get key 701p is operated.

Likewise, the Get key 701q of the ID administrator's remote control unit 5b is operated in the range in which communication is possible with the AV data receiver 4a, the Get key 701r of the ID administrator's remote control unit 5b is operated in the range in which communication is possible with the AV data receiver 4b, and the Get key 701s of the ID administrator's remote control unit 5b is operated in the range in which communication is possible with the AV data receiver 4c, so that the ID code “A” of the AV data receiver 4a, the ID code “B” of the AV data receiver 4b, and the ID code “C” of the AV data receiver 4c are respectively received. Then, the ID management control portion 571 controls the write operations so that the ID code “A” is stored in the ID storage portion 570q, the ID code “B” is stored in the ID storage portion 570r, and the ID code “C” is stored in the ID storage portion 570s.

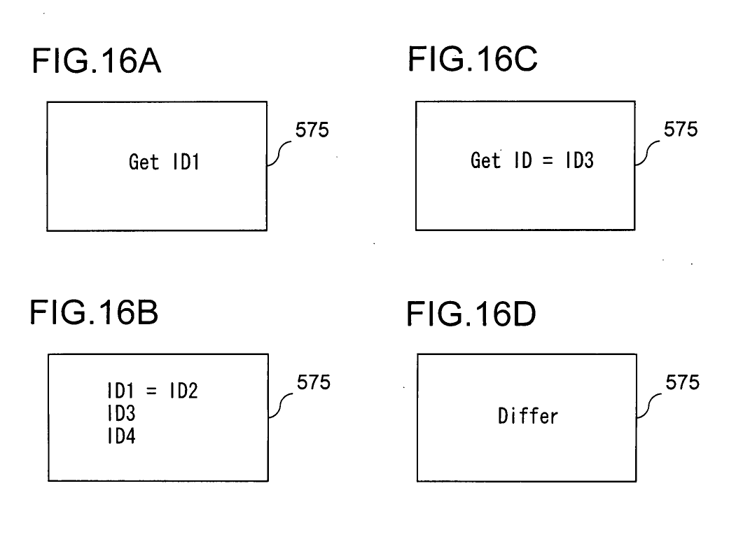

Here, assume that the result display portion 575 displays “ID1” to “ID4” to indicate the ID codes stored in the ID storage portions 570p to 570s, respectively. Then, when the ID code “A” is acquired from the AV data transmitter 3a, the ID management control portion 571 notifies the result display portion 575 that the acquired ID code is stored in the ID storage portion 570p, and thus the result display portion 575 displays, as shown in FIG. 16A: “Get ID1”. Likewise, when the ID codes “A” to “C” are acquired from the AV data receivers 4a to 4c, to indicate that the acquired ID codes are stored in the ID storage portions 570q to 570s, the result display portion 575 displays: “Get ID2”, “Get ID3”, and “Get ID4”.

With the ID codes “A”, “A”, “B”, and “C” stored respectively in the ID storage portions 570p to 570s in this way, when the Chk key 702a is operated, the ID management control portion 571 reads out and compares the ID codes stored respectively in the ID storage portions 570p to 570s. Thus, the ID management control portion 571 compares the ID codes “A”, “A”, “B”, and “C”, and recognizes that the ID codes stored in the ID storage portions 570p and 570q coincide, both being “A”. Thus, a comparison result indicating that the ID codes stored in the ID storage portions 570p and 570q coincide is fed to the communication storage memory 576. Thus, in the communication storage memory 576, of all the ID storage portions 570p to 570s, those which store coincident ID codes are recorded as a group.

Here, the ID management control portion 571 notifies the result display portion 575 that the ID codes stored in the ID storage portions 570p and 570q, both “A”, coincide, and thus, as shown in FIG. 16B, the result display portion 575 displays “ID1=ID2”. On the other hand, no coincidence is found between the ID codes “B” and “C” stored in the ID storage portions 570r and 570s, and therefore, as shown in FIG. 16B, the result display portion 575 displays “ID3” and “ID4” separately.

When the Chk key 702b is operated in the range in which communication is possible with the AV data transmitter 3b, the AV data receiver 4d, or the like, an ID request signal is transmitted from the ID management output portion 573 to the AV data transmitter 3b or the AV data receiver 4d. The AV data transmitter 3b or the AV data receiver 4d then transmits the transmission ID code “B” or the reception ID code “D”, and, when the ID management input portion 572 receives it, the ID management control portion 571 reads out the ID codes “A”, “A”, “B”, and “C” stored in the ID storage portions 570p to 570s.

Then, the received ID code “B” or “D” is compared with each of the ID codes “A”, “A”, “B”, and “C” stored in the ID storage portions 570p to 570s to check whether or not any of these coincides with the received ID code. The result display portion 575 is then notified of the result of the comparison, and displays it. Here, if the ID code “B” of the AV data transmitter 3b has been received, it is recognized as coincident with the ID code “B” of the AV data receiver 4b stored in the ID storage portion 570r, and thus, to indicate that the received ID code coincides with the ID code “B” in the ID storage portion 570r, as shown in FIG. 16C, the result display portion 575 displays “Get ID=ID3”. By contrast, if the ID code “D” of the AV data receiver 4d has been received, it does not coincide with any of the ID codes stored in the ID storage portions 570p to 570s, and thus, to indicate that no coincident ID code is found, as shown in FIG. 16D, the result display portion 575 displays “Differ”.

When the Clr key 703 is operated, the ID management control portion 571 erases all the ID codes “A”, “A”, “B”, and “C” stored in the ID storage portions 570p to 570s and thus the ID storage portions 570p to 570s are emptied. Here, an indication may be displayed on the result display portion 575 to indicate that the ID codes stored in the ID storage portions 570p to 570s have been erased.

When, with the ID codes “A”, “A”, “B”, and “C” stored in the ID storage portions 570p to 570s, any of the Get keys 701p to 701s is operated, the ID code stored in whichever of the ID storage portions 570p to 570s corresponds to the operated one of the Get keys 701p to 701s is erased. Specifically, when the Get key 701p is operated, the ID code “A” in the ID storage portion 570p is erased; when the Get key 701q is operated, the ID code “A” in the ID storage portion 570q is erased; when the Get key 701r is operated, the ID code “B” in the ID storage portion 570r is erased; and, when the Get key 701s is operated, the ID code “C” in the ID storage portion 570s is erased. Here, an indication may be displayed on the result display portion 575 to indicate from which of the ID storage portions 570p to 570s the ID code is erased.

In this embodiment, the states of all the ID storage portions 570p to 570s may be kept displayed all the time on the result display portion 575. In this embodiment, there are provided four ID storage portions 570p to 570s; the number of ID storage portions, however, does not necessarily has to be four, but may be any number greater than or equal to two. Instead of providing a plurality of ID storage portions, it is also possible to divide a single ID storage portion into a plurality of storage areas of which the operation is controlled individually as with the ID storage portions 570p to 570s of this embodiment. In this embodiment, as in the second or third embodiment, the ID codes stored in the ID storage portions may be erased when a predetermined period of time has elapsed after they were stored therein, or when coincidence has been found more than a predetermined number of times.

### Fifth Embodiment

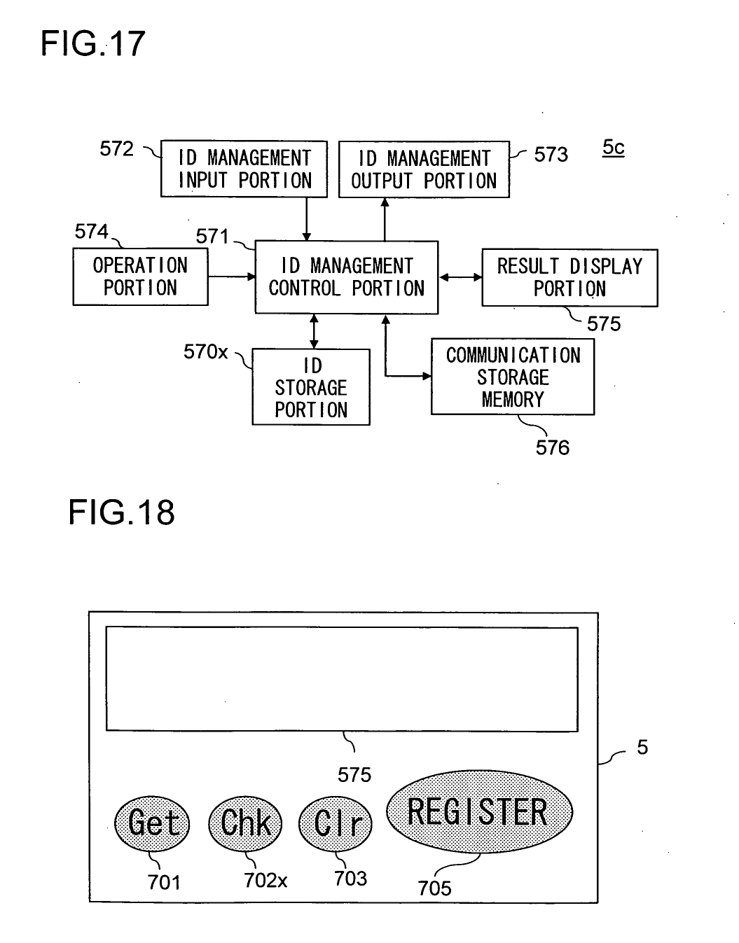

A fifth embodiment of the present invention will be described below with reference to the drawings. In the AV data wireless communication system of this embodiment, the internal configurations of an AV data transmitter 3 and an AV data receiver 4 are the same as in the first embodiment, i.e., as shown in FIGS. 2 and 3. FIG. 17 is a block diagram showing the internal configuration of an ID administrator's remote control unit 5c in this embodiment. In FIG. 17, such blocks as are found also in FIG. 13 are identified with common reference numerals, and their detailed explanations will not be repeated.

The ID administrator's remote control unit 5c shown in FIG. 17 is provided with, instead of the ID storage portions 570p to 570s provided in the ID administrator's remote control unit 5b shown in FIG. 13, an ID storage memory 570x. As shown in FIG. 20, this ID storage memory 570x has different areas allocated to different ID codes stored therein, and in the area allocated to each ID code are recorded the code name and code type of the ID code and the installation site and device type of the device to which the ID code is assigned.

Moreover, as shown in FIG. 18, the ID administrator's remote control unit 5c is provided with, as the operation portion 574: a Get key 701; a Chk key 702x that is operated to compare the ID codes stored in the ID storage memory 570x; a Clr key 703 that is operated to erase the ID codes stored in the ID storage memory 570x; and a registration key 705 that is operated to register the installation site and device type of the devices to which the ID codes stored in the ID storage memory 570x are assigned.

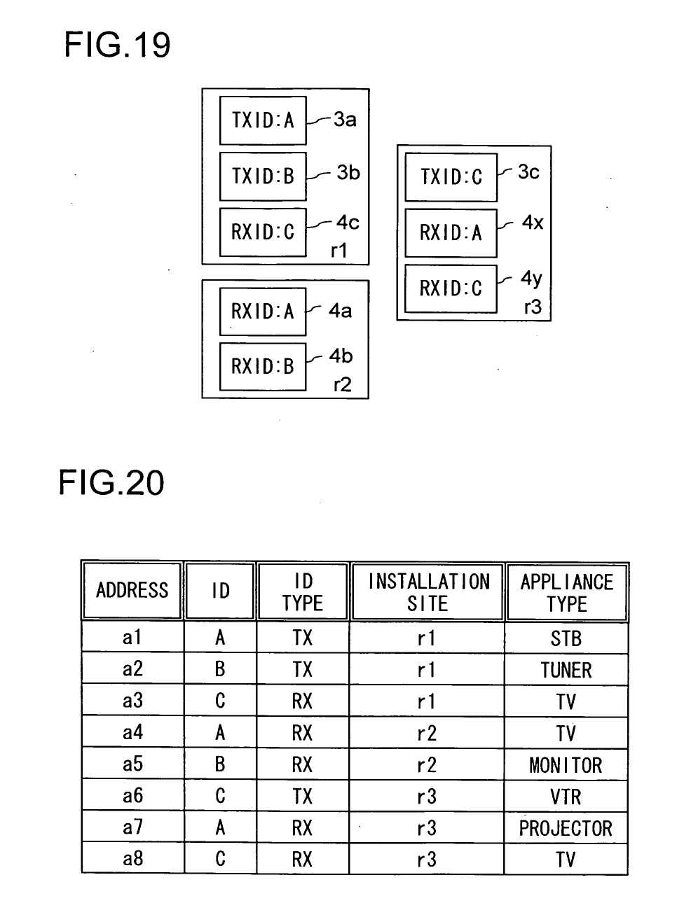

With the ID administrator's remote control unit 5c configured as described above, assume that, as shown in FIG. 19, there are installed AV data transmitters 3a to 3c and AV data receivers 4a to 4c, 4x, and 4y. Specifically, the AV data transmitters 3a and 3b and the AV data receiver 4c are installed in a room “r1”, the AV data receivers 4a and 4b are installed in a room “r2”, and the AV data transmitter 3c and the AV data receivers 4x and 4y are installed in a room “r3”. Here, the AV data transmitter 3a and the AV data receivers 4a and 4x are assigned an ID code “A”, the AV data transmitter 3b and the AV data receiver 4b are assigned an ID code “B”, and the AV data transmitter 3c and the AV data receivers 4c and 4y are assigned an ID code “C”.

With the AV data transmitters 3a to 3c and the AV data receivers 4a to 4c, 4x, and 4y installed as described above,.when the Get key 701 of the ID administrator's remote control unit 5c is operated in the range within which communication with the AV data transmitter 3a in the room “r1” is possible, an ID request signal is transmitted to the AV data transmitter 3a, and, in return, the transmission ID code “A” of the AV data transmitter 3a is received. When this transmission ID code “A” is received, the registration key 705 is operated to register the information that the AV data transmitter 3a is installed in the room “r1” and that the AV data transmitter 3a is an STB (set-top box). Thus, as shown in FIG. 20, in the storage area at an address “a1” in the ID storage memory 570x are recorded, along with the ID code “A”: “TX” indicating that it is a transmission ID code; “r1” indicating the installation site of the AV data transmitter 3a; and “STB” indicating the device type of the AV data transmitter 3a.

Likewise, for each of the AV data transmitter 3b and the AV data receiver 4c in the room “r1”, the AV data receivers 4a and 4b in the room “r2”, and the AV data transmitter 3c and the AV data receivers 4x and 4y in the room “r3”, the Get key 701 of the ID administrator's remote control unit 5c is operated in the range within which communication with the device is possible so that the ID code thereof is acquired, and then the registration key 705 is operated to enter the installation site and device type thereof. In this way, as shown in FIG. 20, in the storage areas at addresses “a2” to “a8” are stored the ID codes of the individual devices, the types of the ID codes, and the installation site and device types of the devices together.

With the ID codes of the AV data transmitters 3a to 3c and the AV data receivers 4a to 4c, 4x, and 4y stored in the ID storage memory 570x as shown in FIG. 20, when the Chk key 702x is operated, the ID codes stored in the ID storage memory 570x are read out by the ID management control portion 571 so as to be compared with one another. Then, based on coincidence among them, the ID codes are classified into groups. Here, to indicate the relationship among the ID codes thus classified into groups, for each group, the addresses of the ID codes belonging to that group are recorded in the communication storage memory 576, and in addition the ID codes are displayed group-by-group on the result display portion 575.

Specifically, the AV data transmitter 3a and the AV data receivers 4a and 4x constitute a group “g1” in which communication is conducted with the ID code “A”, and thus, as the group “g1”, the combination of the addresses “a1”, “a4”, and “a7” is stored in the communication storage memory 576. Likewise, as a group “g2” in which communication is conducted with the ID code “B”, the combination of the addresses “a2” and “a5” is stored in the communication storage memory 576. Likewise, as a group “g3” in which communication is conducted with the ID code “C”, the combination of the addresses “a3”, “a6”, and “a8” is stored in the communication storage memory 576.

Thus, the ID management control portion 571, by referring to the communication storage memory 576, can recognize that the ID codes of the individual devices that build an AV data wireless communication system as the group “g1” are stored in the storage areas at the addresses “a1”, “a4”, and “a7” in the ID storage memory 570x. Then, by reading out the data recorded in the storage areas at the addresses “a1”, “a4”, and “a7” in the ID storage memory 570x, the ID management control portion 571 recognizes that, within the AV data wireless communication system built as the group “g1”, the STB 3a in the room “r1” is on the transmitting side, and the television 4a in the room “r2” and the projector 4x in the room “r3” are on the receiving side.

Likewise, the ID management control portion 571 recognizes the transmitting-side and receiving-side devices in the AV data wireless communication systems built as the groups “g2” and “g3” by first referring to the communication storage memory 576 to find the addresses at which the ID codes of the devices constituting those groups are stored and then reading out the data at those addresses in the ID storage memory 570x. The result display portion 575 is then notified of the individual devices thus confirmed to build each of the AV data wireless communication systems of the groups “g1” to “g3”.

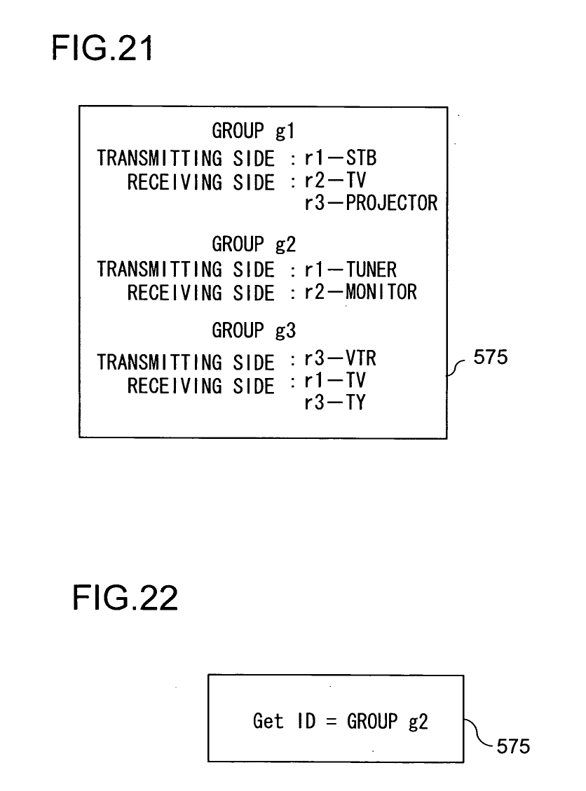

Thus, as shown in FIG. 21, the result display portion 575 displays, for each of the AV data wireless communication systems of the groups “g1” to “g3”, the installation sites and device types of the transmitting-side devices and the installation sites and device types of the receiving-side devices. Specifically, the result display portion 575 displays the following group-by-group: for the group “g1”, “Transmitting side: r1-STB; Receiving side: r2-TV, r3-Projector”; for the group “g2”, “Transmitting side: r1-Tuner; Receiving side: r2-Monitor”; and for the group “g3”, “Transmitting side: r3-VTR; Receiving side: r1-TV, r3-TV”. In a case where two or more devices of the same type are installed in the same room, they may be distinguished by being assigned different numbers. The types of devices may be distinguished by their product names.

Once the Chk key 702 is operated and the groups building individual AV data wireless communication systems are recognized as described above, when the Get key 701 is operated in the range within which communication is possible with another AV data transmitter 3 or AV data receiver 4, the ID code thereof is stored in the ID storage memory 570x, and then the ID management control portion 571 compares the received ID code with the ID code of each group. Then, the group with the same ID code as the acquired ID code is identified, and the address at which the received ID code is stored in the ID storage memory 570x is, in combination with the group with the same ID code, stored in the communication storage memory 576. Moreover, the result display portion 575 displays the group with the same ID code as the received ID code.

Specifically, suppose that, as an AV data receiver having an ID code “B” assigned thereto, a projector 4z is installed in a room “r4”. When the Get key 701 of the ID administrator's remote control unit 5c is operated in the range within which communication with the projector 4z is possible, the ID code “B” of the projector 4z is received, and is stored at an address “a9” in the ID storage memory 570x. Since this ID code “B” is the one used in the AV data wireless communication system of the group “g2”, the ID management control portion 571 recognizes the projector 4z as belonging to the group “g2”, and thus stores the address “a9” in combination with the addresses “a2” and “a5”, i.e., as the group “g2”, in the communication storage memory 576.

Here, as shown in FIG. 22, the result display portion 575 displays “Get ID=Group g2” to indicate that the projector 4z belongs to the AV data wireless communication system of group “g2”. Furthermore, when the registration key 704 is operated, the information that the device is installed in the room “r4” and that the device is of the “projector” type is recorded in the storage area at the address “a9”. When the Clr key 703 is operated, the data stored in the ID storage portion 570x is erased.

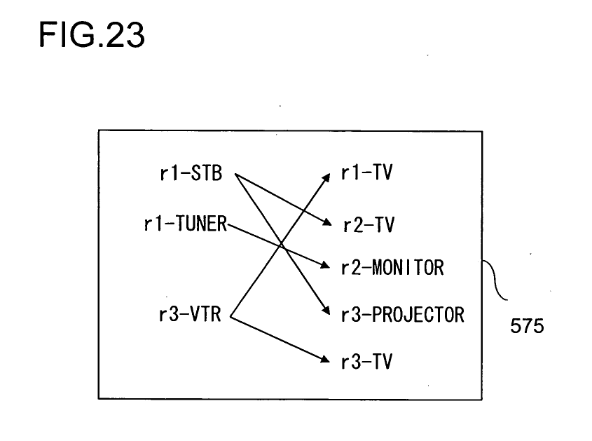

In this embodiment, when indicating the AV data wireless communication systems built by individual groups, the result display portion 575 is assumed to show a display, for example, as shown in FIG. 21; however, the result display portion 575 may show any other display. For example, as shown in FIG. 23, the relationship between the AV data transmitters 3 and AV data receivers 4 stored in the ID storage memory 570x may be shown by displaying, along with the installation sites and device types of the individual devices, arrows indicating how AV data is transmitted and received among them.

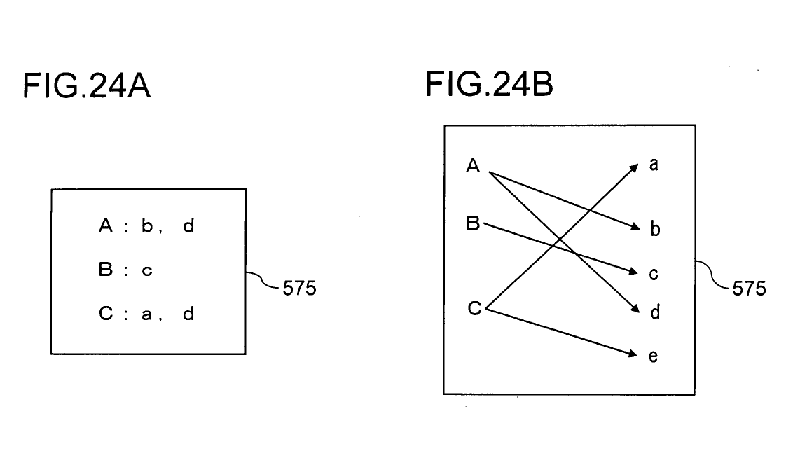

Alternatively, as shown in FIGS. 24A or 24B, symbols may be assigned to the AV data transmitters 3 and AV data receivers 4 stored in the ID storage memory 570x so that how AV data is transmitted and received among them is indicated by using those symbols on the result display portion 575. FIG. 24A shows an example of a group-by-group display, and FIG. 24B shows an example of a display in which arrows are used to indicate how AV data is transmitted and received. In FIGS. 24A and 24B, “A” represents “r1-STB”, “B” represents “r1-Tuner”, “C” represents “r3-VTR”, “a” represents “r1-TV”, “b” represents “r2-TV”, “c” represents “r2-Monitor”, “d” represents “r3-Projector”, and “e” represents “r3-TV”.

### Sixth Embodiment

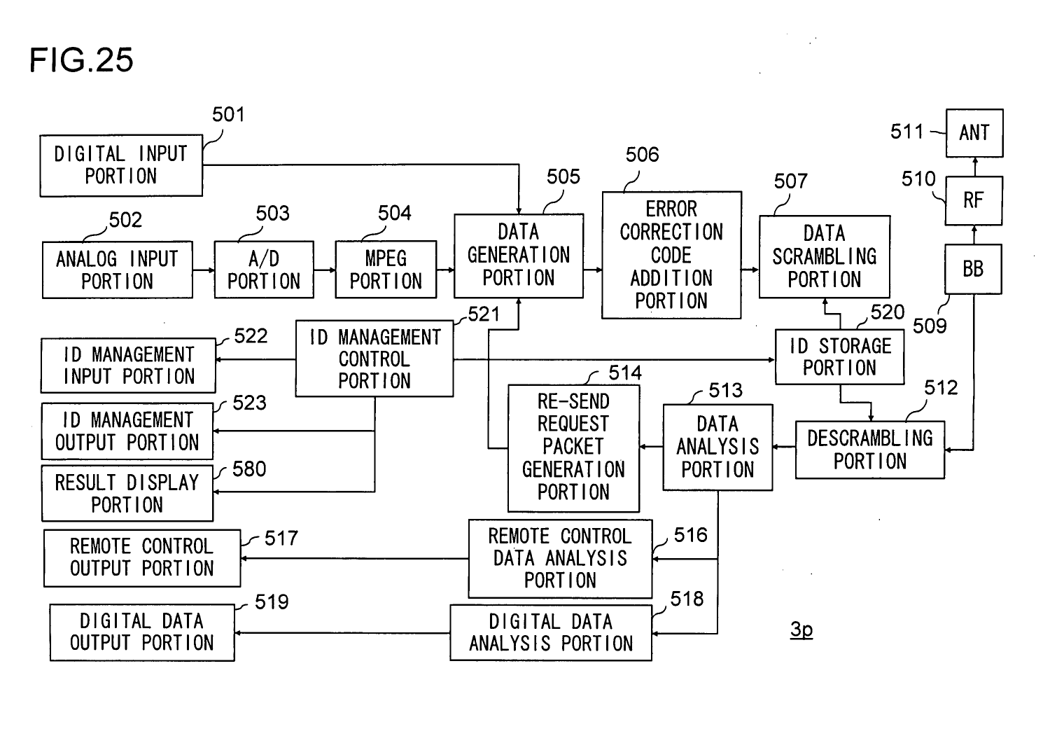

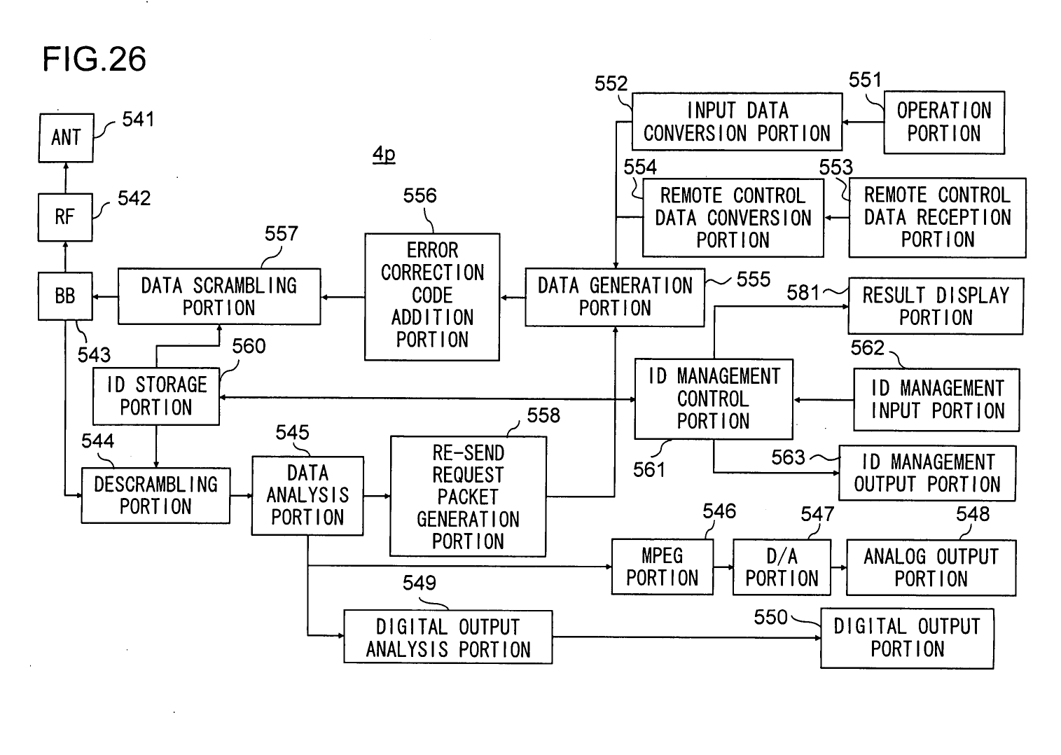

A sixth embodiment of the present invention will be described below with reference to the drawings. FIG. 25 is a block diagram showing the internal configuration of an AV data transmitter in this embodiment. FIG. 26 is a block diagram showing the internal configuration of an AV data receiver in this embodiment. In FIGS. 25 and 26, such blocks as are found also in FIGS. 2 and 3 are identified with common reference numerals, and their detailed explanations will not be repeated.

As compared with the AV data transmitter 3 shown in FIG. 2, the AV data transmitter 3p shown in FIG. 25 is additionally provided with a result display portion 580 that displays comparison results transmitted from an ID administrator's remote control unit 5, 5a, 5b, or 5c (FIGS. 4, 9, 13, or 17), which operates as already described in connection with the first to fifth embodiment. Likewise, as compared with the AV data receiver 4 shown in FIG. 3, the AV data receiver 4p shown in FIG. 26 is additionally provided with a result display portion 581 that displays comparison results transmitted from an ID administrator's remote control unit 5, 5a, 5b, or 5c.

The AV data transmitter 3p and the AV data receiver 4p are configured as described above, and the communication connection relationship among individual devices as obtained by comparing the IDs stored in and received by the ID administrator's remote control unit 5, 5a, 5b, or 5c is transmitted. Specifically, for example, in a case where the ID administrator's remote control unit 5 is used, after an ID code is stored in the ID storage portion 570, when the Get key 701 is operated, the received ID code is compared with the ID code stored in the ID storage portion 570, and the result of the comparison is transmitted from the ID management output portion 573.

This is received, via the ID management input portion 522 (562), by the AV data transmitter 3p (AV data receiver 4p) that is communicating with the ID administrator's remote control unit 5. Thereafter, based on the received comparison result, the result display portion 580 (581) displays “Same” or “Differ”. Here, the parenthesized alternatives are those blocks which operate when the AV data receiver 4p is communicating with the ID administrator's remote control unit 5.

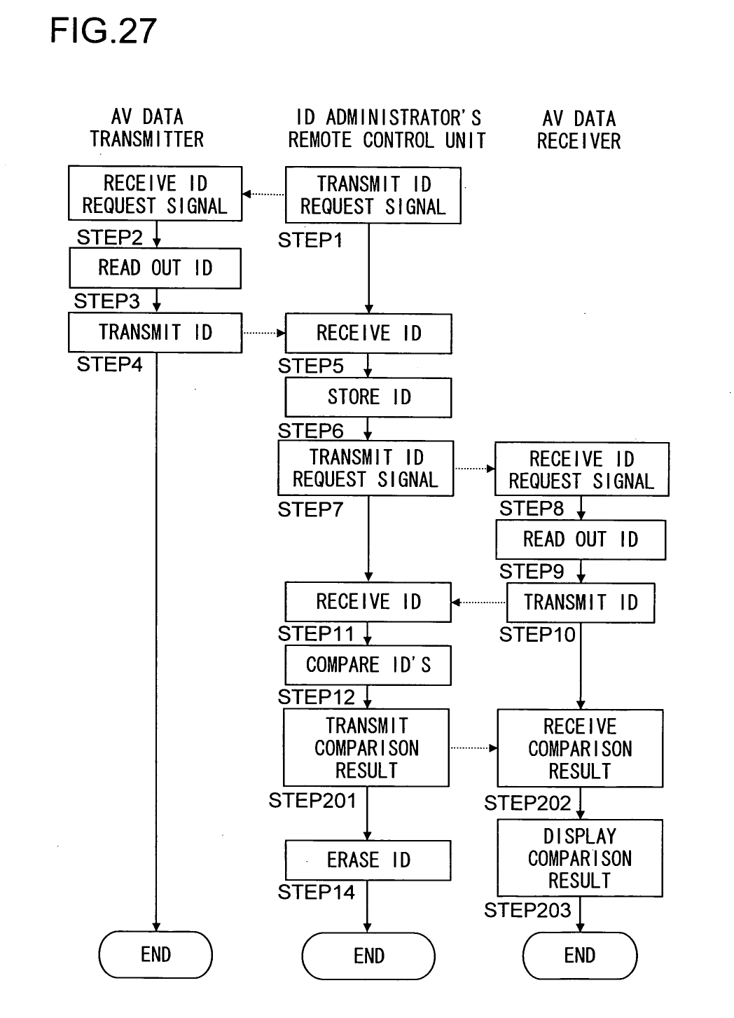

Specifically, as shown in a state transition diagram in FIG. 27, as in the state transition diagram in FIG. 5, first, the operations in STEP 1 to STEP 6 are performed between the AV data transmitter 3p and the ID administrator's remote control unit 5, so that the ID code of the AV data transmitter 3p is stored in the ID storage portion 570. Then, the operations in STEP 7 to STEP 12 are performed between the AV data receiver 4p and the ID administrator's remote control unit 5, so that the ID code of the AV data receiver 4p is compared with the ID code of the AV data transmitter 3p stored in the ID storage portion 570 of the ID administrator's remote control unit 5.

Then, the ID administrator's remote control unit 5 transmits the result of the comparison by the ID management control portion 571 via the ID management output portion 573 to the AV data receiver 4b (STEP 201), and the ID code in the ID storage portion 570 is erased (STEP 14). When the comparison result from the ID administrator's remote control unit 5 is received by the ID management input portion 562 (STEP 202), this comparison result is recognized by the ID management control portion 561, and is fed to the result display portion 581, so that the result of the comparison in the ID administrator's remote control unit 5 is displayed on the result display portion 581 of the AV data receiver 4p (STEP 203).

Also when an ID administrator's remote control unit 5, 5a, 5b, or 5c used in any of the second to fifth embodiments is used, the result of comparison is transmitted in a similar manner so that, in the AV data transmitter 3p or AV data receiver 4p that has received the comparison result, the communication connection relationship among individual devices is displayed on the result display portion 580 or 581 as on the result display portion 575 of the ID administrator's remote control unit 5, 5a, 5b, or 5c used in any of the second to fifth embodiments.

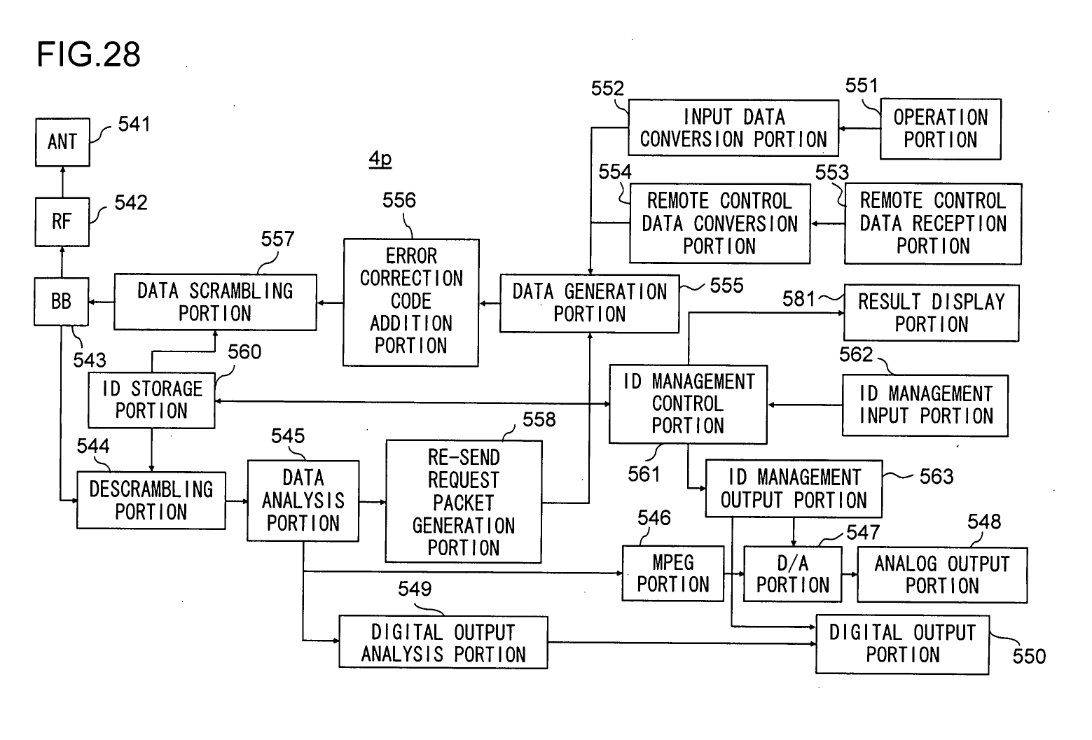

In this embodiment, as shown in FIG. 28, the AV data receiver 4p may be so configured that the comparison result received from the ID administrator's remote control unit 5, 5a, 5b, or 5c is outputted from the ID management control portion 561 via the D/A 547 and the analog output portion 548, or via the digital output portion 550, to the AV reproduction appliance 2. In this case, the communication connection relationship among individual devices as obtained from the result of the comparison by the 5, 5a, 5b, or 5c can be displayed on the AV reproduction appliance 2.

### Seventh Embodiment

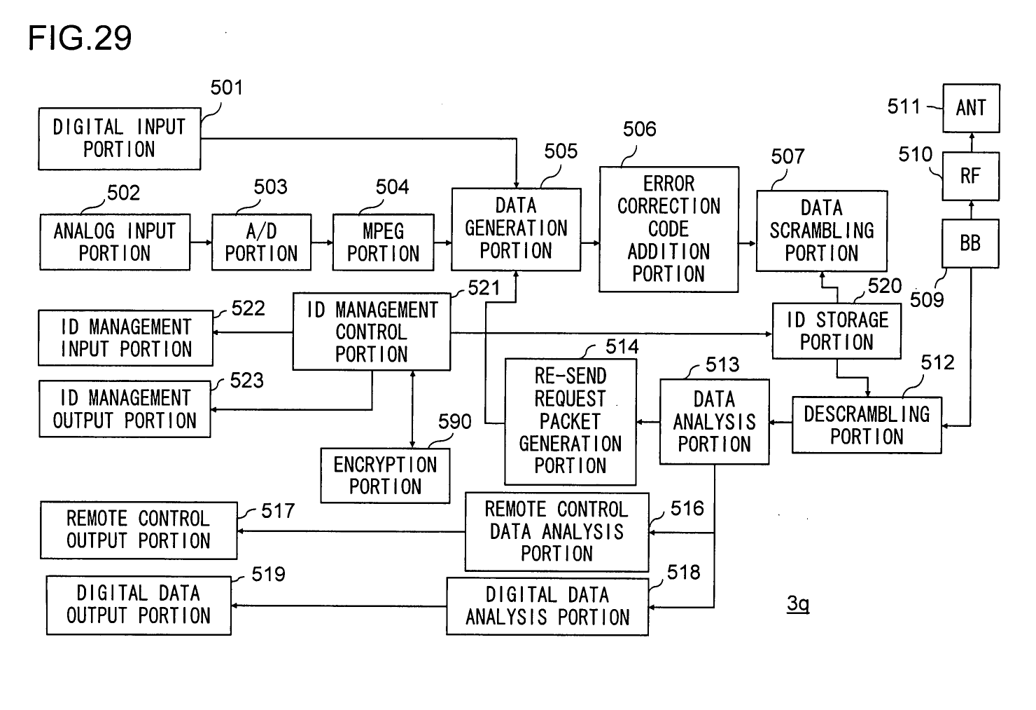

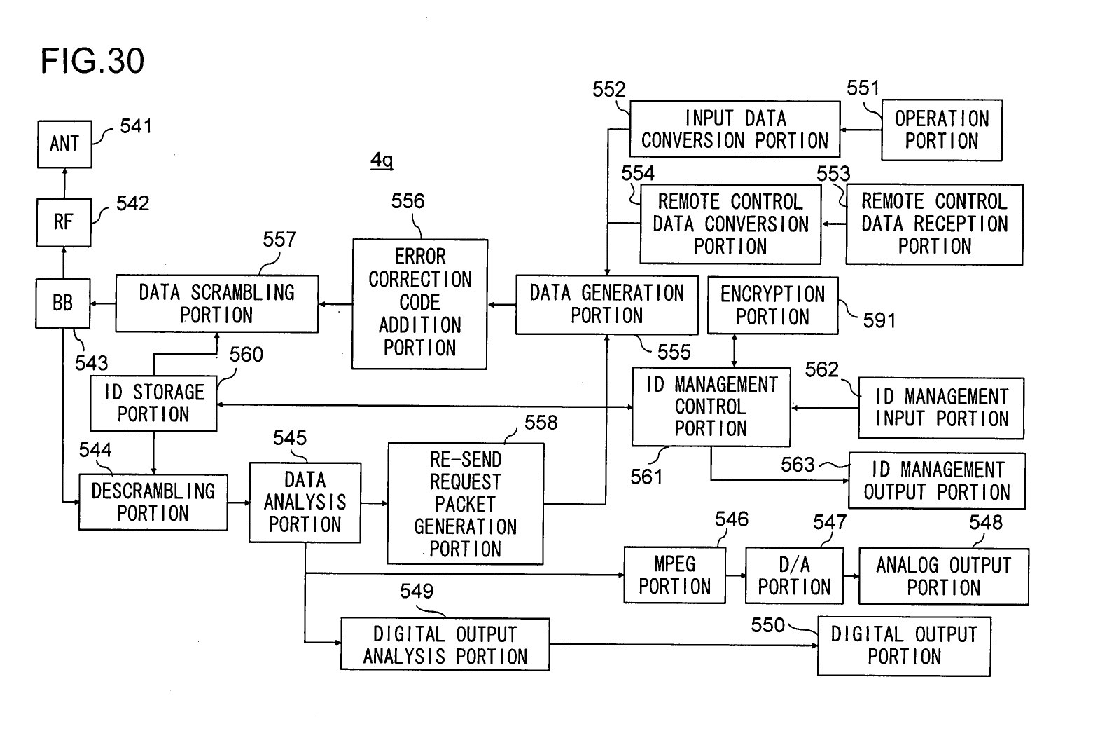

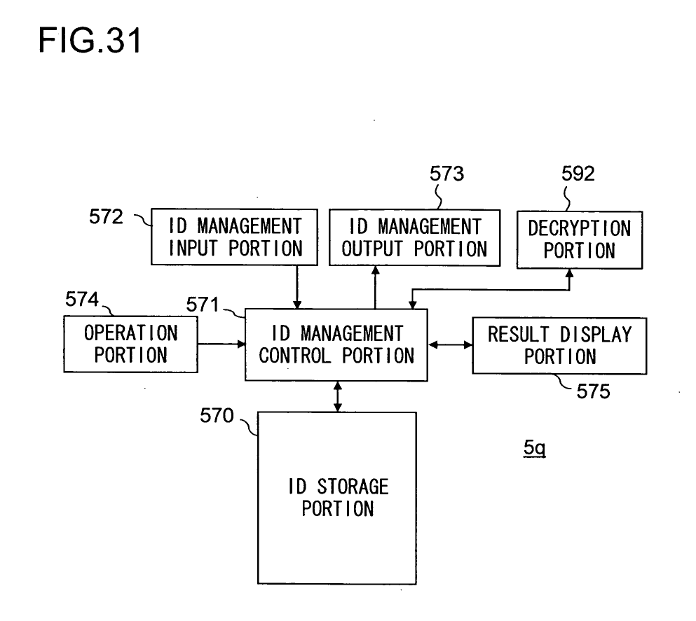

A seventh embodiment of the present invention will be described below with reference to the drawings. FIG. 29 is a block diagram showing the internal configuration of an AV data transmitter in this embodiment. FIG. 30 is a block diagram showing the internal configuration of an AV data receiver in this embodiment. FIG. 31 is a block diagram showing the internal configuration of an ID administrator's remote control unit in this embodiment. In FIGS. 29 to 31, such blocks as are found also in FIGS. 2 to 4 are identified with common reference numerals, and their detailed explanations will not be repeated.

As compared with the AV data transmitter 3 shown in FIG. 2, the AV data transmitter 3q shown in FIG. 29 is additionally provided with an encryption portion 590 that encrypts the ID code in the ID storage portion 520. As compared with the AV data receiver 4 shown in FIG. 3, the AV data receiver 4q shown in FIG. 30 is additionally provided with an encryption portion 591 that encrypts the ID code in the ID storage portion 560. As compared with the ID administrator's remote control unit 5 shown in FIG. 4, the ID administrator's remote control unit 5q shown in FIG. 31 is additionally provided with a decryption portion 592 that decrypts the received ID code.

With the AV data transmitter 3q, the AV data receiver 4q, and the ID administrator's remote control unit 5q configured as described above, as against in the first embodiment, the AV data transmitter 3q and the AV data receiver 4q transmit encrypted ID codes, and the ID administrator's remote control unit 5q decrypts the ID codes it receives. In other respects, the operations performed here are the same as in the first embodiment.

When the AV data transmitter 3q (AV data receiver 4q) receives, via the ID management input portion 522 (562) an ID request signal from the ID administrator's remote control unit 5q, the ID code read out from the ID storage portion 520 (560) by the ID management control portion 521 (561) is fed to the encryption portion 590 (591) so as to be encrypted. This encrypted ID code is then transmitted from the ID management output portion 523 (563) to the ID administrator's remote control unit 5q.

When the ID administrator's remote control unit 5q receives the encrypted ID code from the AV data transmitter 3q (AV data receiver 4q), the ID management control portion 571 stores the received ID code, in its encrypted form, in the ID storage portion 570. When the ID administrator's remote control unit 5q, now having the encrypted ID code stored in the ID storage portion 570, receives the encrypted ID code from the AV data receiver 4q (AV data transmitter 3q), the ID code stored in the ID storage portion 570 and the received ID code are sent from the ID management control portion 571 to the decryption portion 592. These two ID codes are decrypted by the decryption portion 592, and are then compared by the ID management control portion 571. The result of the comparison is fed to the result display portion 575 so as to be displayed, and then the ID code in the ID storage portion 570 is erased.

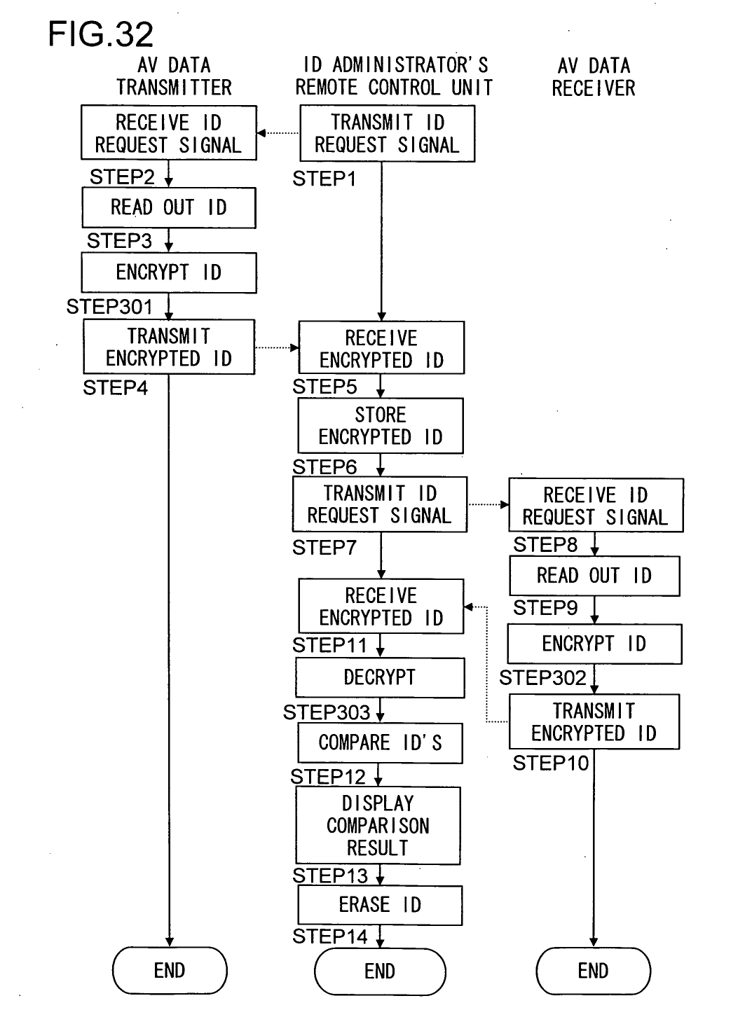

Specifically, as shown in a state transition diagram in FIG. 32, as in the state transition diagram in FIG. 5, first, the operations in STEP 1 to STEP 3 are performed between the AV data transmitter 3q and the ID administrator's remote control unit 5q, so that the ID code of the AV data transmitter 3q having received an ID request signal is read out from the ID storage portion 520. This ID code read out from the ID storage portion 520 is then encrypted by the encryption portion 590 (STEP 301). Then, the operations in STEP 4 to STEP 6 are performed between the AV data transmitter 3q and the ID administrator's remote control unit 5q, so that the encrypted ID code is stored in the ID storage portion 570 of the ID administrator's remote control unit 5q.

Next, the operations in STEP 7 to STEP 9 are performed between the AV data receiver 4q and the ID administrator's remote control unit 5q, so that the ID code of the AV data receiver 4q having received an ID request signal is read out from the ID storage portion 560. This ID code read out from the ID storage portion 560 is then encrypted by the encryption portion 591 (STEP 302). Then, the operations in STEP 10 and STEP 11 are performed between the AV data receiver 4q and the ID administrator's remote control unit 5q, so that the encrypted ID code transmitted from the AV data receiver 4q is received by the ID administrator's remote control unit 5q.

Then, the ID code stored in the ID storage portion 570 in STEP 6 and the ID code received in STEP 11 are fed to the decryption portion 592, and these two ID codes are descrambled (STEP 303). The two descrambled ID codes are then compared by the ID management control portion 571, the result of the comparison is fed to the result display portion 575 so as to be displayed, and the ID code in the ID storage portion 570 is erased (STEP 12 to STEP 14).

The encryption key that is used by the encryption portions 590 and 591 to perform encryption in the AV data transmitter 3q and the AV data receiver 4q may be stored in the encryption portions 590 and 591 in advance, or may be transmitted along with the ID request signal from he ID administrator's remote control unit 5q. Alternatively, when the encryption key is stored in the encryption portions 590 and 591, the encryption key may be transmitted along with the encrypted ID code to the ID administrator's remote control unit 5q. Alternatively, every time encryption is performed, the encryption key may be changed. In this case, the encryption key may be changed according to time. It is also possible to compare the encrypted ID codes in the ID administrator's remote control unit 5q.

This embodiment assumes that the encryption of ID codes is applied to the first embodiment. Alternatively, the ID administrator's remote control unit 5, 5a, 5b, or 5c of any of the second to fifth embodiments may be additionally provided with a decryption portion 592 so as to be able to decrypt the encrypted ID codes transmitted from the AV data transmitter 3q and the AV data receiver 4q and thereby recognize the communication connection relationship among individual devices. In this case, except when decrypting the received ID codes, the ID administrator's remote control unit 5, 5a, 5b, or 5c operates in the same manner as in the second to fifth embodiment.

Moreover, as in the sixth embodiment, the AV data transmitter 3q and the AV data receiver 4q may be additionally provided with a result display portion so that the comparison result indicating the communication connection relationship among individual devices is transmitted to the AV data transmitter 3q and AV data receiver 4q. In the ID administrator's remote control unit 5q, the stored ID code may be erased when a predetermined period of time has elapsed after the ID code was stored, or when the number of devices having a coincident ID code has reached a predetermined number, or in response to an instruction entered via the operation portion 574.

### Eighth Embodiment

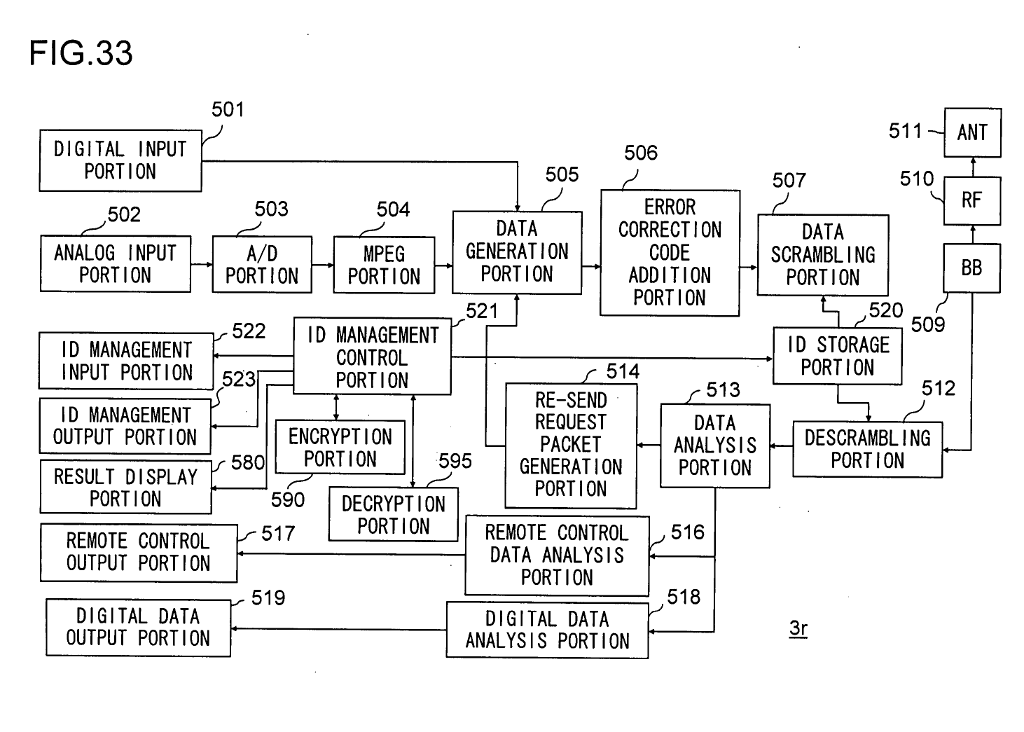

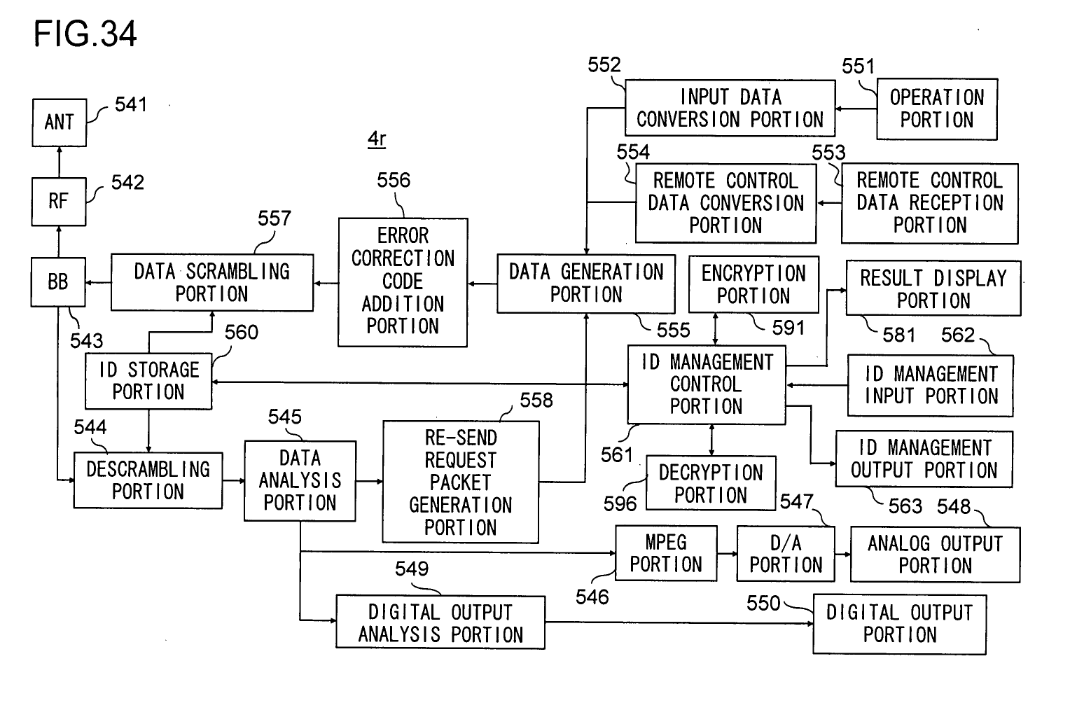

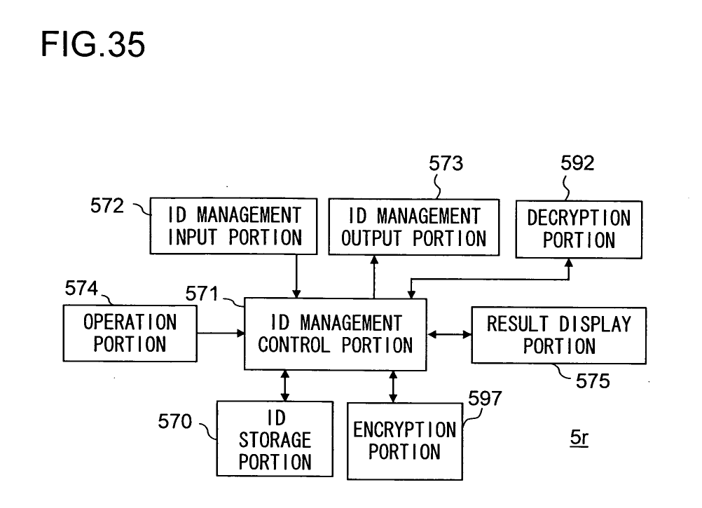

An eighth embodiment of the present invention will be described below with reference to the drawings. FIG. 33 is a block diagram showing the internal configuration of an AV data transmitter in this embodiment. FIG. 34 is a block diagram showing the internal configuration of an AV data receiver in this embodiment. FIG. 35 is a block diagram showing the internal configuration of an ID administrator's remote control unit in this embodiment. In FIGS. 33 to 35, such blocks as are found also in FIGS. 29 to 31 are identified with common reference numerals, and their detailed explanations will not be repeated.

As compared with the AV data transmitter 3q shown in FIG. 29, the AV data transmitter 3r shown in FIG. 33 is additionally provided with an decryption portion 595 and a result display portion 580. As compared with the AV data receiver 4q shown in FIG. 30, the AV data receiver 4r shown in FIG. 34 is additionally provided with an decryption portion 596 and a result display portion 581. As compared with the ID administrator's remote control unit 5q shown in FIG. 31, the ID administrator's remote control unit 5r shown in FIG. 35 is additionally provided with an encryption portion 597.

The result display portions 580 and 581 operate in a similar manner to the result display portions 580 and 581 in the AV data transmitter 3p and the AV data receiver 4p of the sixth embodiment. Except for the decryption portion 595, the AV data transmitter 3r operates in a similar manner to the AV data transmitter 3q. Except for the decryption portion 596, the AV data receiver 4r operates in a similar manner to the AV data receiver 4q. Except for the encryption portion 597, the ID administrator's remote control unit 5r operates in a similar manner to the ID administrator's remote control unit 5q.

With the AV data transmitter 3r, the AV data receiver 4r, and the ID administrator's remote control unit 5r configured as described above, as against in the seventh embodiment, the ID administrator's remote control unit 5r receives encrypted ID codes from the AV data transmitter 3r and the AV data receiver 4r, then decrypts them, and then stores them. The ID administrator's remote control unit 5r then transmits the stored ID codes, after encrypting them back, to the AV data transmitter 3r and the AV data receiver 4r with which the ID administrator's remote control unit 5 next communicates. The AV data transmitter 3r and the AV data receiver 4r having received the encrypted ID codes then decrypt them, and then compare them with their own ID codes.

Here, the ID code encrypted by the encryption portion 590 (591) and stored in the ID storage portion 520 (560) is transmitted from the ID management output portion 523 (563) of the AV data transmitter 3r (AV data receiver 4r) to the ID administrator's remote control unit 5r. When this encrypted ID code is received by the ID administrator's remote control unit 5r, it is decrypted by the decryption portion 592, and is then stored in the ID storage portion 570.

Thereafter, when the ID administrator's remote control unit 5r communicates with the AV data receiver 4r (AV data transmitter 3r), the ID code stored in the ID storage portion 570 is read out, is then encrypted by the encryption portion 597, and is then transmitted from the ID management output portion 573, while the ID code in the ID storage portion 570 is erased. When this encrypted ID code is received by the AV data receiver 4r (AV data transmitter 3r) via the ID management input portion 562 (522), it is sent from the ID management control portion 561 (521) to the decryption portion 596 (595). The received ID code is then decrypted by the decryption portion 596 (595), and is then compared with the ID code in the ID storage portion 560 (520) by the ID management control portion 561 (521). The result of the comparison is then fed to the result display portion 581 (580) so as to be displayed.

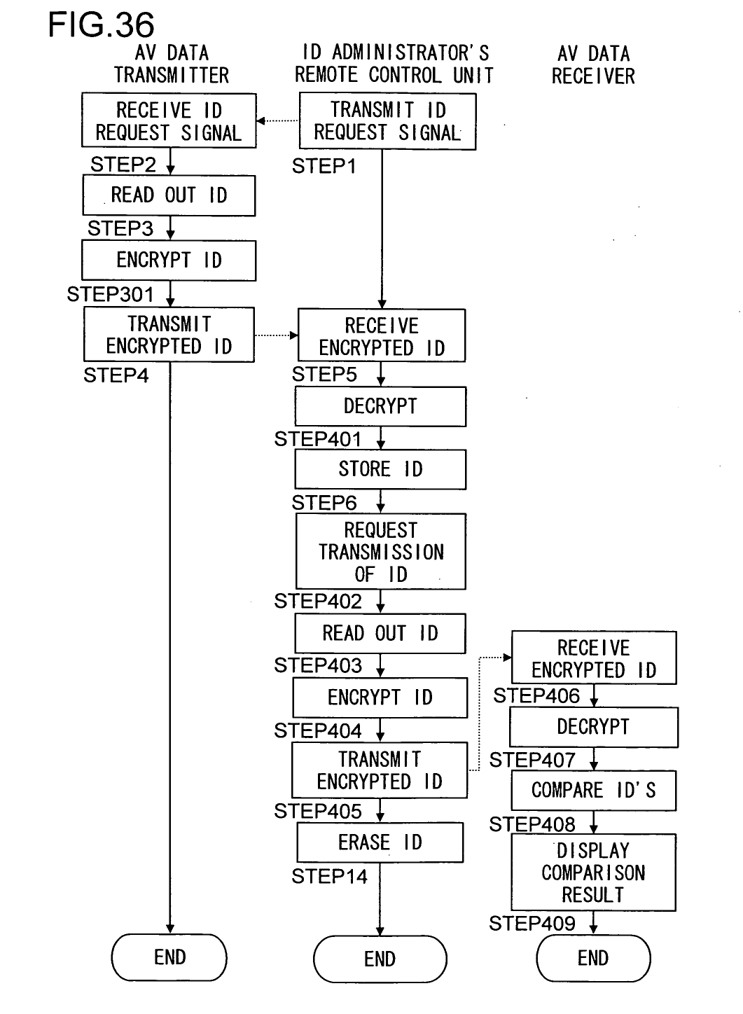

Specifically, as shown in a state transition diagram in FIG. 36, as in the state transition diagram in FIG. 33, first, the operations in STEP 1 to STEP 5 and STEP 301 are performed between the AV data transmitter 3r and the ID administrator's remote control unit 5r, so that the ID code of the AV data transmitter 3r having received an ID request signal is encrypted, is then transmitted, and is then received by the ID administrator's remote control unit 5r. The encrypted ID code is then sent to the decryption portion 597 so as to be decrypted (STEP 401), and is then stored in the ID storage portion 570 (STEP 6).

Next, when the operation portion 574 is operated in the range within which commutation with the AV data receiver 4r is possible and thereby the transmission of the ID code is requested (STEP 402), the ID code stored in the ID storage portion 570 is read out by the ID management control portion 571 (STEP 403), and is then encrypted by the encryption portion 592 (STEP 404). This encrypted ID code is then transmitted from the ID management output portion 573 (STEP 405), and is thus received by the ID management input portion 563 of the AV data receiver 4r (STEP 406). Here, in the ID administrator's remote control unit 5r, the ID code stored in the ID storage portion 570 is erased (STEP 14).

Thereafter, in the AV data receiver 4r, the received ID code is sent from the ID management control portion 561 to the decryption portion 596 so as to be decrypted (STEP 407). The decrypted ID code is then compared with the ID code stored in the ID storage portion 560 by the ID management control portion 561 (STEP 408). The result of the comparison is then fed to the result display portion 581 so as to be displayed (STEP 409).

In this embodiment, the ID code stored in the ID administrator's remote control unit 5r is first decrypted, is then encrypted, and is then transmitted. Alternatively, the ID administrator's remote control unit here may be, like the ID administrator's remote control unit 5, so configured as to include no decryption portion or encryption portion. In this case, the AV data transmitter 3r and the AV data receiver 4r may be so configured as to decrypt the ID codes transmitted from the ID administrator's remote control unit 5.

In this embodiment, the communication connection relationship is recognized by decrypting the ID codes received by the AV data transmitter 3r and the AV data receiver 4r and then comparing them with their own ID codes. Alternatively, the communication connection relationship may be recognized based on whether or not the received ID codes can be decrypted at all.

The encryption key that is used by the encryption portions 590 and 591 to perform encryption in the AV data transmitter 3r and the AV data receiver 4r may be stored in the encryption portions 590 and 591 in advance, or may be transmitted along with the ID request signal from he ID administrator's remote control unit 5r. Alternatively, when the encryption key is stored in the encryption portions 590, 591 and 597, the encryption key may be transmitted along with the encrypted ID code to the transmission destination. Alternatively, every time encryption is performed, the encryption key may be changed. In this case, the encryption key may be changed according to time.

In this embodiment, as in the second embodiment, the ID code stored in the ID storage portion 570 may be kept stored there until a predetermined period of time elapses, or until the number of times that coincidence has been found exceeds a predetermined number, or until erasure is requested. In this case, the ID code stored in the ID storage portion 570 is, so long as it is stored there, transmitted to a plurality of AV data transmitters 3r and AV data receivers 4r, so that the AV data transmitters 3r and AV data receivers 4r having received the ID code recognize the communication connection relationship.

As in the sixth embodiment, the ID administrator's remote control unit 5r may be so configured that IDs are compared by the ID management control portion 571 and the result of the comparison, which indicates the communication connection relationship among individual devices, is transmitted after being encrypted by the encryption portion 597. In this case, when the encrypted comparison result is received by the AV data transmitter 3r and the AV data receiver 4r via the ID management input portion 522 and 562, it is decrypted by the decryption portion 595 and 596, and is then sent to the result display portion 580 and 581, respectively.

This embodiment assumes that the encryption of ID codes is applied to the first embodiment; instead, it may be applied to the third to fifth embodiments. Specifically, in STEP 403 to STEP 405 of the state transition diagram in FIG. 36, the ID administrator's remote control unit reads out a plurality of ID codes from the ID storage portion, then encrypts them, and then transmits them to the AV data transmitter 3r or the AV data receiver 4r. Here, each ID code has appended thereto a code for identifying the device to which the ID code is assigned.

Thus, in STEP 406 to STEP 409, the AV data transmitter 3r or AV data receiver 4r having received the plurality of ID codes decrypts them, then compares them with its own ID code to identify devices of which the ID code coincides therewith, and then displays the result on the result display portion. Alternatively, a device may recognize the communication connection relationship among individual devices based on a plurality of ID codes including that of the device itself, and then outputs the result on the result display portion.

In any of the first to eighth embodiments, when the ID codes are transmitted from the AV data transmitter and the AV data receiver to the ID administrator's remote control unit, the device names of the individual devices may be transmitted together. In this case, when the comparison result is displayed on the result display portion in the ID administrator's remote control unit, AV data transmitter, or AV data receiver, the device names of individual devices may be displayed.

The ID management input portion and the ID management output portion may be designed as part of an infrared transmission/reception portion for exchanging remote control data; for example, the ID management input portion may be incorporated in the remote control output portion, and the ID management output portion may be incorporated in the remote control data reception portion. Instead of displaying the comparison result on the result display portion, it is also possible to indicate the result by lighting or blinking a light-emitting device or the like, or by audibly outputting the comparison result from a loudspeaker or the like.

The first to eighth embodiments all deal with AV data wireless communication systems as differently configured examples of ID management systems. It is, however, also possible to use the ID management system of any of the embodiments described above in wireless communication systems that conduct wired or wireless communication of any data other than AV data.

### INDUSTRIAL APPLICABILITY

According to the present invention, in an electronic apparatus or data processor, it is possible to output to a result output portion the communication connection relationship among a plurality of data processors building a wireless communication system. This permits the user to recognize the communication connection relationship among the individual data processors easily by checking the output from the result output portion. By so doing, the user can check whether or not failure of data exchange between particular data processors is due to disagreement of encryption codes. Moreover, even if a data processor is installed at a remote place, the electronic apparatus permits recognition of its communication connection relationship.

Moreover, since the electronic apparatus can automatically acquire an encryption code form a data processor, it does not require the user to enter an encryption code. This leads to easy operation. Moreover, since encryption codes are not directly displayed, they can be protected from leakage. Moreover, since encryption codes are encrypted when exchanged between data processors and the electronic apparatus, it is possible to realize a safe system that prevents leakage of encryption codes.

1. An encryption code management system for use in a plurality of communication systems composed of a plurality of data processors that exchange data encrypted with specific encryption codes,
wherein there is provided an electronic apparatus including:
a code management reception portion that receives the encryption codes of the data processors;
a code management control portion that compares a plurality of the encryption codes received by the code management reception portion; and
a result output portion that outputs a comparison result yielded by the code management control portion, and
wherein the data processors include a code management transmission portion that transmits the encryption codes of the data processors themselves to the electronic apparatus.

2. The encryption code management system of claim 1, wherein the data processors include an encryption portion that encrypts a signal transmitted from the code management transmission portion to the electronic apparatus.

3. The encryption code management system of claim 2, wherein the electronic apparatus includes a decryption portion that decrypts the signal received by the code management reception portion from the data processors.

4. The encryption code management system of claim 2, wherein an encryption key to be used to encrypt the encryption codes is transmitted from a side that receives the encryption codes and the comparison result.

5. The encryption code management system of claim 4, wherein the encryption key used for encryption in the data processors is transmitted along with a code request signal transmitted by the electronic apparatus to request the data processors to transmit the encryption codes.

6. The encryption code management system of claim 2, wherein an encryption key having been used to encrypt the encryption codes is transmitted, along with the encryption codes and the comparison result, from a side that transmits the encryption codes.

7. The encryption code management system of claim 1,
wherein the electronic apparatus includes a code storage portion that stores one or a plurality of the encryption codes received, and
wherein the electronic apparatus
first receives, via the code management reception portion, the encryption codes from the data processors and then stores the received encryption codes in the code storage portion,
then receives, via the code management reception portion, the encryption codes from the data processors other than those corresponding to the encryption codes stored in the code storage portion, and
then compares, in the code management control portion, the encryption codes received by the code management reception portion with the encryption codes stored in the code storage portion to search for coincidence, and then yields a search result as the comparison result.

8. The encryption code management system of claim 7, wherein, when the electronic apparatus recognizes that a predetermined period of time has passed after the encryption codes were stored in the code storage portion, the electronic apparatus erases the encryption codes from the code storage portion.

9. The encryption code management system of claim 7, wherein, when the electronic apparatus recognizes that coincidence with the encryption codes stored in the code storage portion has been found more than a predetermined number of times, the electronic apparatus erases the encryption codes from the code storage portion.

10. The encryption code management system of claim 7, wherein the electronic apparatus includes an erasure operation portion that erases from the code storage portion the encryption codes stored therein.

11. The encryption code management system of claim 7,
wherein the electronic apparatus includes, one for each of the data processors with which the electronic apparatus has communicated, registration keys with which to register identification codes by which the data processors are identified, and
wherein the electronic apparatus stores in the code storage portion the encryption codes along with the identification codes registered with the registration keys.

12. The encryption code management system of claim 11, wherein, in the result output portion of the electronic apparatus or the data processors, the communication systems composed of a plurality of the data processors among which the encryption codes are coincident are indicated by displaying the identification codes thereof to indicate groups to which the plurality of data processors belong.

13. The encryption code management system of claim 11, wherein the identification codes are installation positions and types of the data processors.

14. The encryption code management system of claim 11, wherein the identification codes are device names of the data processors.

15. The encryption code management system of claim 1,
wherein the electronic apparatus includes a code storage portion that stores a plurality of the encryption codes received, and
wherein the electronic apparatus
first receives, via the code management reception portion, the encryption codes of the plurality of the data processors and then stores the received encryption codes in the code storage portion, and
then compares, in the code management control portion, all the encryption codes stored in the code storage portion to confirm, as the comparison result, communication connection relationships between the data processors among which the encryption codes are coincident.

16. The encryption code management system of claim 15, wherein the electronic apparatus
first receives, via the code management reception portion, the encryption codes from the data processors other than those corresponding to the plurality of the encryption codes stored in the code storage portion, and
then compares, in the code management control portion, the encryption codes received by the code management reception portion with the plurality of the encryption codes stored in the code storage portion to search for coincidence, and then yields a search result as the comparison result.

17. The encryption code management system of claim 1, wherein, in the result output portion of the data processors or the electronic apparatus, a plurality of the data processors among which the encryption codes are coincident and that thus build one communication system are displayed as one group.

18. The encryption code management system of claim 1 wherein, when the encryption codes are exchanged, the encryption codes are exchanged along with device names of the data processors with which the encryption codes are associated.

19. The encryption code management system of claim 1, wherein the electronic apparatus is a remote control unit for operating the data processors.

20. The encryption code management system of claim 1, wherein the data exchanged between the data processors is AV data.

21. An encryption code management system for use in a plurality of communication systems composed of a plurality of data processors that exchange data encrypted with specific encryption codes,
wherein there is provided an electronic apparatus including:
a code management reception portion that receives the encryption codes of the data processors;
a code management control portion that compares a plurality of the encryption codes received by the code management reception portion; and
a code management transmission portion that transmits a comparison result yielded by the code management control portion to the data processors, and
wherein the data processors include:
a code management transmission portion that transmits the encryption codes of the data processors themselves to the electronic apparatus;
a code management reception portion that receives the comparison result from the electronic apparatus; and
a result output portion that outputs the comparison result received by the code management reception portion.

22. The encryption code management system of claim 21,
wherein the data processors include:
an encryption portion that encrypts a signal to be transmitted from the code management transmission portion to the electronic apparatus; and
a decryption portion that decrypts a signal having received by the code management reception portion from the electronic apparatus, and
wherein the electronic apparatus includes:
an encryption portion that encrypts a signal to be transmitted from the code management transmission portion to the data processors; and
a decryption portion that decrypts a signal having received by the code management reception portion from the data processors.

23. The encryption code management system of claim 22, wherein an encryption key to be used to encrypt the encryption codes is transmitted from a side that receives the encryption codes and the comparison result.

24. The encryption code management system of claim 23, wherein the encryption key used for encryption in the data processors is transmitted along with a code request signal transmitted by the electronic apparatus to request the data processors to transmit the encryption codes.

25. The encryption code management system of claim 22, wherein an encryption key having been used to encrypt the encryption codes is transmitted, along with the encryption codes and the comparison result, from a side that transmits the encryption codes.

26. An encryption code management system for use in a plurality of communication systems composed of a plurality of data processors that exchange data encrypted with specific encryption codes,
wherein there is provided an electronic apparatus including:
a code management reception portion that receives the encryption codes of the data processors;
a code storage portion that stores one or a plurality of the encryption codes received by the code management reception portion; and
a code management transmission portion that transmits the encryption codes stored in the code storage portion to the data processors, and
wherein the data processors include:
a code management transmission portion that transmits the encryption codes of the data processors themselves to the electronic apparatus;
a code management reception portion that receives the encryption codes transmitted from the electronic apparatus;
a code management control portion that compares the encryption codes received by the code management reception portion with the encryption codes of the data processors themselves; and
a result output portion that outputs a comparison result yielded by the code management control portion.

27. The encryption code management system of claim 26, wherein, when the electronic apparatus recognizes that a predetermined period of time has passed after the encryption codes were stored in the code storage portion, the electronic apparatus erases the encryption codes from the code storage portion.

28. The encryption code management system of claim 26, wherein, when the electronic apparatus recognizes that coincidence with the encryption codes stored in the code storage portion has been found more than a predetermined number of times, the electronic apparatus erases the encryption codes from the code storage portion.

29. The encryption code management system of claim 26, wherein the electronic apparatus includes an erasure operation portion that erases from the code storage portion the encryption codes stored therein.

30. The encryption code management system of claim 26, wherein, in the result output portion of the data processors or the electronic apparatus, a plurality of the data processors among which the encryption codes are coincident and that thus build one communication system are displayed as one group.

31. The encryption code management system of claim 26,
wherein the electronic apparatus includes, one for each of the data processors with which the electronic apparatus has communicated, registration keys with which to register identification codes by which the data processors are identified, and
wherein the electronic apparatus stores in the code storage portion the encryption codes along with the identification codes registered with the registration keys.

32. The encryption code management system of claim 31, wherein, in the result output portion of the electronic apparatus or the data processors, the communication systems composed of a plurality of the data processors among which the encryption codes are coincident are indicated by displaying the identification codes thereof to indicate groups to which the plurality of data processors belong.

33. The encryption code management system of claim 31, wherein the identification codes are installation positions and types of the data processors.

34. The encryption code management system of claim 31, wherein the identification codes are device names of the data processors.

35. The encryption code management system of claim 26 wherein, when the encryption codes are exchanged, the encryption codes are exchanged along with device names of the data processors with which the encryption codes are associated.

36. The encryption code management system of claim 26, wherein the electronic apparatus is a remote control unit for operating the data processors.

37. The encryption code management system of claim 26, wherein the data exchanged between the data processors is AV data.

38. A data processor used as one of data processors that build a communication system employing the encryption code management system of claim 1.

39. An electronic apparatus used in the encryption code management system of claim 1.
